(19) United States
(12) Patent Application Publication
(10) Pub. No.: US 2022/0055223 A1
(43) Pub. Date: Feb. 24, 2022

(54) ELECTRONIC DEVICE FOR PROVIDING REACTION ON BASIS OF USER STATE AND OPERATING METHOD THEREFOR

(71) Applicant: Samsung Electronics Co., Ltd., Gyeonggi-do (KR)

(72) Inventors: Kawon CHEON, Gyeonggi-do (KR); Younju JIN, Gyeonggi-do (KR); Hyunjoo KANG, Gyeonggi-do (KR); Jaeyeon RHO, Gyeonggi-do (KR); Yongyeon LEE, Gyeonggi-do (KR)

(21) Appl. No.: 17/415,900

(22) PCT Filed: Dec. 20, 2019
(86) PCT No.: PCT/KR2019/018249

§ 371 Date: Jun. 18, 2021

(30) Foreign Application Priority Data
Dec. 21, 2018 (KR) 10-2018-0167351

(51) Int. Cl. B25J 11/00; B25J 13/08; B25J 13/00

(52) U.S. Cl. CPC B25J 11/0005; B25J 13/003; B25J 13/08

(57) ABSTRACT

Various embodiments of the present invention relate to an electronic device for providing a reaction on the basis of a user state and an operating method therefor. Here, the electronic device comprises: at least one sensor; a communication module for communicating with an external device; a memory for storing reaction sets including at least one piece of reaction information corresponding to each of a plurality of interaction elements; and a processor, wherein the processor may determine an interaction element on the basis of a user's state sensed through the at least one sensor, provide a reaction related to the user's state on the basis of a first reaction set corresponding to the determined interaction element, refine the frequency of use of the determined interaction element, obtain at least one piece of other reaction information related to the determined interaction element from at least one of the memory or the external device on the basis of the refined frequency of use, and add the at least one piece of other reaction information to the first reaction set. Other embodiments are also possible.

### TECHNICAL FIELD

Various embodiments of the present disclosure relate to an electronic device for offering a reaction on the basis of a user state and an operating method therefor.

### BACKGROUND ART

With the growth of technologies, electronic devices (e.g., mobile terminals, smart phones, wearable devices, social robots, etc.) can provide various functions. For example, the electronic device can provide various functions such as a voice communication function, a data communication function, a short-range wireless communication (e.g., Bluetooth, near field communication (NFC), etc.) function, a mobile communication (e.g., 3-generation (3G), 4G, 5G, etc.) function, a music or video play function, a photo or video photographing function, or a navigation function, etc.

Particularly, the social robot can provide a service which uses artificial intelligence (AI). For example, the social robot can provide a service which reacts to a user's emotion state by using the artificial intelligence.

### DISCLOSURE OF INVENTION

### Technical Problem

An electronic device providing an artificial intelligence service such as a social robot can recognize a user's emotion state, and provide a previously specified reaction by emotion state. However, there is a limit in satisfying user's various desires by just a scheme of providing the specified reaction as above.

Accordingly, various embodiments of the present disclosure are to provide a method and apparatus for providing various reactions on the basis of a user state in an electronic device.

Technological solutions the present document seeks to achieve are not limited to the above-mentioned technological solutions, and other technological solutions not mentioned above would be able to be clearly understood by a person having ordinary skill in the art from the following statement.

### Solution to Problem

According to various embodiments of the present disclosure, an electronic device can include at least one sensor, a communication module for communicating with an external device, a memory for storing reaction sets including at least one piece of reaction information corresponding to each of a plurality of interaction elements, and a processor. The processor can determine an interaction element on the basis of a user's state which is obtained through the at least one sensor, offer a reaction related to the user state on the basis of a first reaction set corresponding to the determined interaction element, refine the frequency of use of the determined interaction element, and acquire at least one piece of other reaction information related to the determined interaction element from at least one of the memory or the external device on the basis of the refined use frequency and add the at least one piece of other reaction information to the first reaction set.

According to various embodiments of the present disclosure, an operating method of an electronic device can include determining an interaction element on the basis of a user's state which is obtained through at least one sensor, offering a reaction related to the user state on the basis of a first reaction set corresponding to the determined interaction element, refining the frequency of use of the determined interaction element, and acquiring at least one piece of other reaction information related to the determined interaction element from at least one of a memory or the external device on the basis of the refined use frequency and add the at least one piece of other reaction information to the first reaction set.

### Advantageous Effects of Invention

An electronic device of various embodiments of the present disclosure can digitize the frequency of use of an interaction element which is based on a user state, and extend a reaction set of the interaction element on the basis of the digitized frequency of use, thereby offering a reaction reflecting a user's disposition for each interaction element and accordingly to this, improving a user's satisfaction.

### BRIEF DESCRIPTION OF DRAWINGS

FIG. 1 is a block diagram of an electronic device within a network environment according to various embodiments.

FIG. 2 is a block diagram of a program in an electronic device according to various embodiments.

FIG. 3 is a flowchart of extending a reaction set of an interaction element on the basis of a user state in an electronic device according to various embodiments.

FIG. 4 is an example diagram of refining the frequency of use of an interaction element in an electronic device according to various embodiments.

FIG. 5 is a flowchart of determining an interaction element in an electronic device according to various embodiments.

FIG. 6 is an example diagram of determining an interaction element on the basis of a user behavior in an electronic device according to various embodiments.

FIG. 7 is a flowchart of offering a reaction of an interaction element in an electronic device according to various embodiments.

FIG. 8A to FIG. 8C are example diagrams showing a reaction set associated with a use frequency for each emotion according to various embodiments.

FIG. 9 is an example diagram showing a reaction for each emotion associated with a user state in an electronic device according to various embodiments.

FIG. 10 is an example diagram for a reaction offered by emotion in an electronic device according to various embodiments.

FIG. 11 is a flowchart of digitizing the frequency of use of an interaction element related to etiquette in an electronic device according to various embodiments.

FIG. 12 is a flowchart of digitizing the frequency of use of an interaction element related to a time in an electronic device according to various embodiments.

FIG. 13A is a flowchart of digitizing the frequency of use of an interaction element related to an emotion in an electronic device according to various embodiments.

FIG. 13B is an example diagram of digitizing the frequency of use of an interaction element related to an emotion in an electronic device according to various embodiments.

FIG. 14A is a flowchart of digitizing the frequency of use of an interaction element related to a sense in an electronic device according to various embodiments.

FIG. 14B is an example diagram of digitizing the frequency of use of an interaction element related to a sense in an electronic device according to various embodiments.

FIG. 15 is a flowchart of digitizing the frequency of use of an interaction element related to a promise in an electronic device according to various embodiments.

FIG. 16 is a flowchart of digitizing the frequency of use of an interaction element related to a mission in an electronic device according to various embodiments.

FIG. 17 is a flowchart of extending a reaction set of an interaction element in an electronic device according to various embodiments.

FIG. 18 is an example diagram of extending a reaction set of an interaction element in an electronic device according to various embodiments.

FIG. 19 is a flowchart of extending a reaction set of an interaction element in an electronic device according to various embodiments.

FIG. 20A and FIG. 20B are example diagrams of extending reaction sets of interaction elements in an electronic device according to various embodiments.

FIG. 21A is a graph showing a character of an electronic device associated with an emotion expression frequently used in an electronic device according to various embodiments.

FIG. 21B and FIG. 21C are example diagrams showing a character of an electronic device associated with a reaction set for each emotion in an electronic device according to various embodiments.

FIG. 22 is an example diagram of offering a mission according to the extension of a reaction set of a mission related element in an electronic device according to various embodiments.

### BEST MODE FOR CARRYING OUT THE INVENTION

Various embodiments of the present document are mentioned below with reference to the accompanying drawings. It should be appreciated that an embodiment and the terms used therein do not intend to limit the technology set forth therein to a particular embodiment form, and include various modifications, equivalents, and/or alternatives of the corresponding embodiment. In relation to a description of the drawing, like reference symbols can be used for like components. The expression of a singular form can include the expression of a plural form unless otherwise dictating clearly in context.

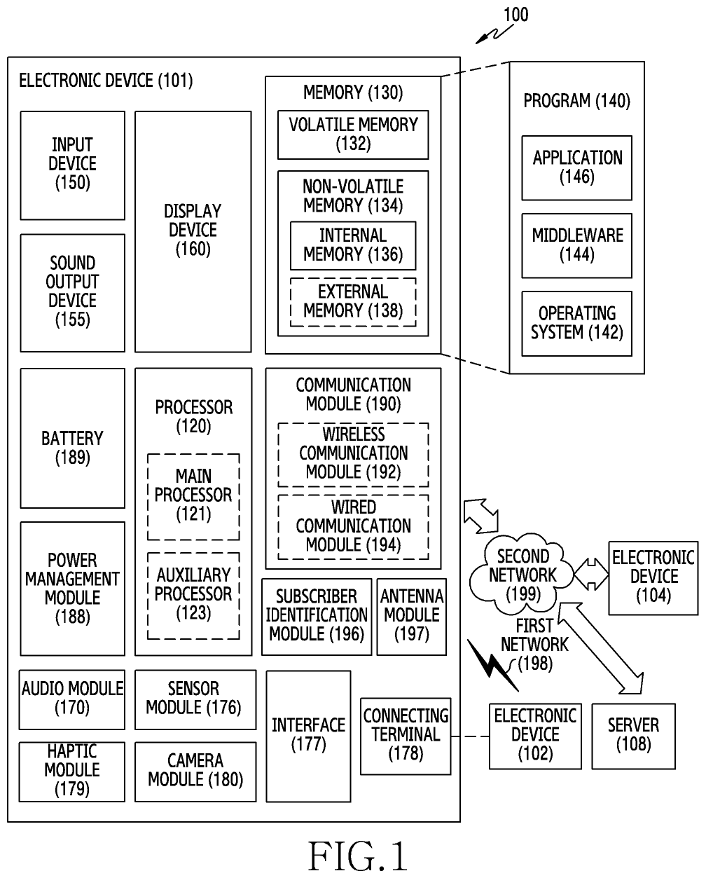

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module(SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121. The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.
The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.
The program 140 may be stored in the memory 130 as software, and may include, for example, an operating system (OS) 142, middleware 144, or an application 146.
The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).
The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.
The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.
The action module 163 may perform expression change expression, posture expression, or driving. According to an embodiment, the action module 163 may include a facial expression motor, a posture expression motor, or a driving unit. The facial expression motor may visually provide a state of the electronic device 101 through, for example, the display device 160. The driving unit may be used to mechanically change the movement of the electronic device 101 and other components, for example. The driving unit may be, for example, a shape capable of rotating up/down, left/right, or clockwise/counterclockwise around at least one or more axes. The driving unit, for example, may be implemented by combining a drive motor (e.g., a wheel type wheel, a sphere type wheel, a continuous track, or a propeller), or may be implemented by controlling independently. The driving unit may be, for example, a driving motor that moves at least one of a head axis, a trunk axis, or an arm joint of the robot. For example, the driving unit may include a driving motor that adjusts the head axis to rotate the head of the robot in an up/down, left/right, or clockwise/counterclockwise direction. The driving unit may include a drive motor that tilts the body of the robot forward/backward, rotates 360 degrees, or adjusts the body axis to rotate by a specified angle. The driving unit may include a driving motor that adjusts the arm of the robot to rotate or bend in an up/down, left/right, or clockwise/counterclockwise direction.
The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.
The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.
The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.
A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).
The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.
The camera module 180 may capture a still image or moving images. According to an embodiment, the camera module 180 may include one or more lenses, image sensors, image signal processors, or flashes.
The power management module 188 may manage power supplied to the electronic device 101. According to one embodiment, the power management module 188 may be implemented as at least part of, for example, a power management integrated circuit (PMIC).
The battery 189 may supply power to at least one component of the electronic device 101. According to an embodiment, the battery 189 may include, for example, a primary cell which is not rechargeable, a secondary cell which is rechargeable, or a fuel cell.
The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.
The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.
At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

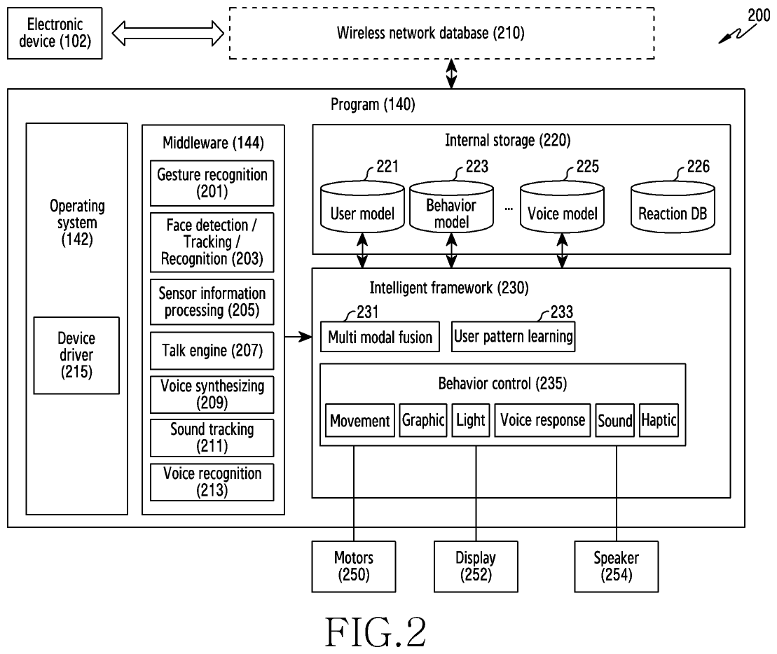

FIG. 2 is a block diagram 200 of a program 140 in the electronic device 101 according to various embodiments. In FIG. 2, the program 1401 can be at least a portion of the program 140 of FIG. 1. Referring to FIG. 2, the program 140 of the electronic device 101 can include an operating system 142 for controlling one or more resources of the electronic device, a middleware 144, an intelligent framework 230, or an internal storage 220. The operating system 142, for example, can include Android™, IOS™, Windows™, Symbian™, Tizen™, or Bada™. At least part of a software program, for example, can be pre-loaded on the electronic device 101 during manufacture, or can be downloaded from or refined by an external electronic device (e.g., the electronic device 102 or the server 108) during use by a user.

The operating system 142 can control management (e.g., allocation or deallocation) of one or more system resources (e.g., a process, a memory, or a power source) of the electronic device. The operating system 142 can additionally or alternatively include one or more device driver 215 programs for driving other hardware devices of the electronic device 101, for example, an input device (e.g., the input device 150 of FIG. 1), a sound output device (e.g., the sound output device 155 of FIG. 1), a display device (e.g., the display device 160 of FIG. 1), a behavior module (e.g., the behavior module 163 of FIG. 1), a camera module (e.g., the camera module 180 of FIG. 1), a power management module (e.g., the power management module 188 of FIG. 1), a battery (e.g., the battery 189 of FIG. 1), a communication module (e.g., the communication module 190 of FIG. 1), a subscriber identification module (e.g., the subscriber identification module 196 of FIG. 1), or an antenna module (e.g., the antenna module 197 of FIG. 1).

The middleware 144 can obtain and track a user's face position by using signal-processed data or perform authentication through face recognition. The middleware can perform a role of recognizing a 3D gesture of a user, a direct of arrival (DOA) for an audio signal, voice recognition, and processing signals of various sensor data. The middleware 144, for example, can include a gesture recognition manager 201, a face obtaining/tracking/recognition manager 203, a sensor information processing manager 205, a talk engine manager 207, a voice synthesizing manager 209, a sound source tracking manager 211, or a voice recognition manager 213.

The internal storage 220, for example, can include a user model DB 221, a behavior model DB 223, a voice model DB 225, or a reaction DB 226. The user model DB 221, for example can store, by user, information learned by the intelligent framework 230. The behavior model DB 223 can store information for behavior control (or operation control) of the electronic device 101. The voice model DB 225, for example, can store information for voice response of the electronic device 101. The reaction DB 226, for example, can store a reaction set of each of interaction elements associated with an interaction with a user. The interaction elements can include at least one of a temporal element, an etiquette related element, an emotional element, a sensible element, a promise related element, or a mission related element. The enumerated interaction elements are just examples for description convenience, and various embodiments of the present disclosure would not be limited to these. The reaction DB 226, for example, can include a reaction set for a happy emotion, a reaction set for a sad emotion, a reaction set for an uneasy emotion, a reaction set for a sense related to tickling, a reaction set for a sense related to hugging, and/or a reaction set for a mission, etc. The reaction set for each interaction element can include information representing at least one reaction. The reaction set for each interaction element can be extended according to a numerical value representing the frequency of use (or a score) of each interaction element. For example, an initial reaction set for a happy emotion can include information representing a first happy reaction and, as a numerical value representing the frequency of use of a happy emotion increases, the initial reaction set for the happy emotion can be extended to include information representing a plurality of happy reactions. According to an embodiment, information representing a reaction can include at least one of expression data, data representing a movement (or an action) of a specific component (e.g., a head, a body, an arm, and/or a leg) of the electronic device, data representing a moving direction, data representing a movement speed, data representing the magnitude of a movement, data related to the output of a display, illumination control data, sound related data, or data about suppliable contents. According to an embodiment, the reaction DB 226 can include information about a suppliable reaction and a non-suppliable reaction according to the frequency of use of each of the interaction elements. According to an embodiment, the reaction DB 226 can be downloaded and/or refined by another electronic device 102 and/or the server 108. For example, the reaction set for each interaction element can be extended by another electronic device 102 and/or the server 108 on the basis of the frequency of use of a corresponding interaction element. According to an embodiment, information stored in each DB can be stored or shared in a wireless network DB 210 (e.g., a cloud). For example, the reaction DB 226 and/or information stored in the reaction DB 226 can be stored or shared in the cloud. According to an embodiment, the reaction DB 226 can be constructed by each user. For example, in response to a user registered to the electronic device 101 being N in number, the reaction DB 226 can be comprised of a reaction DB for a first user, a reaction DB for a second user, . . . , a reaction DB for an Nth user.

The intelligent framework 230, for example, can include a multi modal fusion block 231, a user pattern learning block 233, or a behavior controller block 235. The multi modal fusion block 231, for example, can perform a role of collecting and managing various information processed by the middleware 144. According to an embodiment, on the basis of a user's behavior and the reaction DB 226, the multi modal fusion block 231 can determine an interaction element associated with an interaction with a user, and determine a reaction of the electronic device corresponding to the interaction element. The user pattern learning block 233, for example, can extract and learn meaningful information such as user's life pattern, preference, etc. by using information of the multi modal fusion block 231. For example, the user pattern learning block 233 can learn information about an emotion whose use frequency is low, or information about an emotion whose use frequency is high, on the basis of the interaction element obtained during the interaction with the user. The behavior controller block 235, for example, can express information which will be fed back to the user, through motors 250, a display 252, and/or a speaker 254, by a movement, a graphic (UI/UX), light, a voice response, a sound, or haptic, etc. According to an embodiment, the behavior controller block 235 can offer a reaction to the interaction with the user by using at least one of the movement, the graphic, the light, the voice response, the sound, or haptic.

According to various embodiments, the processor 120 can determine an interaction element for offering a reaction related to a user state, on the basis of the user state. According to an embodiment, the processor 120 can identify a user of the electronic device 101 by using at least one component (e.g., the input device 150, the sensor module 176, or the camera module 180), and determine an interaction element on the basis of a state of the identified user. For example, in response to a voice command being received through the input device 150, the processor 120 can recognize that the user exists around the electronic device 101, and acquire glottis information from the voice command and identify the user. For another example, the processor 120 can analyze an image acquired from the camera module 180 and recognize and identify the user who exists around the electronic device 101. According to an embodiment, the processor 120 can analyze a behavior of the user identified by using at least one component (e.g., the input device 150, the sensor module 176, or the camera module 180) and, on the basis of the analysis result, the processor 120 can determine an interaction element for offering a reaction related to a user state. The interaction element, for example, can include at least one of a temporal element, an etiquette related element, an emotional element, a sensible element, a promise related element, or a mission related element. For example, the processor 120 can determine whether to offer a reaction related to which interaction element among various interaction elements on the basis of the user's behavior analysis result. For instance, in response to it being analyzed that the user is laughing, the processor 120 can determine a happy emotion element as the interaction element wherein a reaction related to a happy emotion is offered. For another example, in response to it being analyzed that the user is performing learning according to a specified schedule, the processor 1180 can determine the temporal element and/or the promise related element as the interaction element wherein a reaction related to a time and/or promise is offered. For further example, in response to it being analyzed that the user is uttering a word related to etiquette or is performing an action related to the etiquette, the processor 120 can determine the etiquette related element as the interaction element wherein a reaction related to the etiquette is offered. For yet another example, in response to it being analyzed that the user is performing a specified mission, the processor 120 can determine the mission element as the interaction element wherein a reaction related to mission execution is offered.

According to various embodiments, the processor 120 can determine a reaction on the basis of a reaction set corresponding to the determined interaction element, and control at least one component included in the electronic device 101 on the basis of the determined reaction, thereby expressing the determined reaction. According to an embodiment, the processor 120 can acquire the reaction set corresponding to the determined interaction element within a reaction DB of a user which is identified from a storage (e.g., the memory 130 and/or the internal storage 220) of the electronic device 101, and determine a reaction which will be offered to the user among at least one reaction included in the acquired reaction set. In response to a plurality of reactions being included in the reaction set corresponding to the determined interaction element, the processor 120 can select one reaction among the plurality of reactions on the basis of weights of the plurality of reactions. According to an embodiment, the weight of each of the plurality of reactions can be set and/or changed by a designer and/or a user. According to an embodiment, the weight of each of the plurality of reactions can be determined on the basis of a time point at which each reaction is added to a corresponding reaction set. For example, a weight of a reaction which is finally added to a reaction set of a corresponding interaction element on the basis of the frequency of use of the corresponding interaction element can be higher than a weight of a reaction included in a reaction set at a previous time point or at an initial period. According to an embodiment, the processor 120 can select a reaction on the basis of the weight of each of the plurality of reactions and the number of offering of each of the plurality of reactions, thereby allowing a reaction of the highest weight among the plurality of reactions to be most offered to the user and a reaction of the lowest weight to be least offered to the user. According to an embodiment, the weight of each of the plurality of reactions can be determined on the basis of whether a corresponding interaction element is an element related to an emotion expression disposition of the electronic device 101. For example, in response to the electronic device 101 most offering (expressing) a reaction to a happy emotion, a weight of each of a plurality of reactions included in a reaction set corresponding to the happy emotion can be determined as a mutually different value, and a weight of each of a plurality of reactions included in a reaction set corresponding to other interaction element besides this can be determined as a mutually identical value. According to an embodiment, the processor 120 can control at least one component included in the electronic device 101 on the basis of the determined reaction, thereby offering the determined reaction to the user. For example, in response to the determined interaction element being a happy emotion element, the processor 120 can determine a first happy reaction on the basis of a reaction set corresponding to the happy emotion element and, on the basis of information representing the first happy reaction, the processor 120 can control at least one of the motors 250, the display 252, or the speaker 254 included in the electronic device 101 and express the first happy reaction. For another example, in response to the determined interaction element being a promise related element, the processor 120 can select story contents most recently added to a reaction set corresponding to the promise related element, and control at least one of the motors 250, the display 252, or the speaker 254 included in the electronic device 101 and offer the selected story contents.

According to various embodiments, the processor 120 can refine the frequency of use of the determined interaction element. The processor 120 can determine a change numerical value for the frequency of use of the determined interaction element, and refine the frequency of use of the corresponding interaction element on the basis of the determined change numerical value. According to an embodiment, in response to the interaction element being a temporal element, the processor 120 can determine the change numerical value on the basis of an interaction time. For example, the processor 120 can determine the change numerical value in proportion to an interaction time with a user such as a learning time or an amusement time. For instance, in response to a total time of learning being 10 minutes, the processor 120 can determine a change numerical value for the frequency of use of the temporal element as a and, in response to the total time of learning being N*10 minutes, the processor 120 can determine the change numerical value for the frequency of use of the temporal element as N*a. For another example, in response to the amusement time being totally 1 hour, the processor 120 can determine the change numerical value for the frequency of use of the temporal element as b and, in response to the amusement time being totally N*1 hours, the processor 120 can determine the change numerical value for the frequency of use of the temporal element as N*b. According to an embodiment, in response to the interaction element being an etiquette related element, the processor 120 can determine the change numerical value on the basis of a word related to etiquette and/or an action related to the etiquette. For example, the processor 120 can determine the change numerical value in proportion to the number of etiquette related words (e.g., words expressing a gratitude, words expressing a favor, etc.) sensed by a user's behavior (e.g., utterance and action) and/or the number of action (e.g., bowing action, etc.) sensing. For instance, in response to an N number of words expressing a gratitude being sensed, the processor 120 can determine the change numerical value for the frequency of use of an etiquette element as N*c. According to an embodiment, in response to the interaction element being an emotional element, the processor 120 can determine the change numerical value on the basis of a priority order corresponding to an emotion. The priority order can be set and/or changed on the basis of the number of expression of a corresponding emotion, and/or user setting. For example, in response to the determined interaction element being a happy emotion, and a priority order corresponding to the happy emotion being a number one order, the processor 120 can determine the change numerical value for the frequency of use of the happy emotion as d. In response to the determined interaction element being a sad emotion, and a priority order corresponding to the sad emotion being a number two order, the processor 120 can determine the change numerical value for the frequency of use of the sad emotion as e. In response to the determined interaction element being an unpleasant emotion, and a priority order corresponding to the unpleasant emotion being a number three order, the processor 120 can determine the change numerical value for the frequency of use of the unpleasant emotion as f. Here, the d, e, and f can satisfy the condition of d>e>f. According to an embodiment, in response to the interaction element being a sensible element, the processor 120 can determine the change numerical value on the basis of the type of a physically sensed interaction, a strength (intensity), the number of times, an area, a location, a time, and/or additional accessory sensing or non-sensing. For example, in response to the type of the physically sensed interaction being poking and the strength corresponding to step 1, the processor 120 can determine the change numerical value for the frequency of use of the sensible element as g. In response to the type of the physically sensed interaction being tickling and the strength corresponding to step 1, the processor 120 can determine the change numerical value for the frequency of use of the sensible element as g. In response to the type of the physically sensed interaction being hugging and the strength corresponding to step 1, the processor 120 can determine the change numerical value for the frequency of use of the sensible element as 2 g. According to an embodiment, in response to the interaction element being a promise related element, the processor 120 can determine the change numerical value on the basis of promise fulfillment or non-fulfillment. For example, in response to a previously registered or specified promise being fulfilled, the processor 120 can determine the change numerical value for the frequency of use of the promise related element as +i and, in response to the previously registered or specified promise not being fulfilled, the processor 120 can determine the change numerical value for the frequency of use of the promise related element as −i or 0. According to an embodiment, in response to the interaction element being a mission related element, the processor 120 can determine the change numerical value on the basis of mission success or non-success. For example, in response to a specified mission succeeding, the processor 120 can determine the change numerical value for the frequency of use of the mission related element as +j and, in response to the specified mission failing, the processor 120 can determine the change numerical value for the frequency of use of the mission related element as −i or 0. In the aforementioned embodiments, the a, b, . . . , i can be constant values, and at least a portion of them can be the same value, and at least a portion can be a mutually different value. The aforementioned schemes of determining the change numerical value are just examples for helping the understanding of the present disclosure, and various embodiments of the present disclosure would not be limited to these.

According to various embodiments, the processor 120 can extend a reaction set of an interaction element on the basis of the frequency of use of the interaction element. According to an embodiment, the processor 120 can, after refining the frequency of use of the interaction element, determine whether to extend a reaction set of the corresponding interaction element on the basis of whether the refined use frequency corresponds to a threshold range. For example, in response to the refined use frequency corresponding to a specified first threshold range (e.g., second threshold>use frequency>first threshold), the processor 120 can determine the extension of a reaction set of the corresponding interaction element and, in response to the refined use frequency not corresponding to the specified first threshold range (e.g., use frequency<first threshold), the processor 120 can determine to maintain, without extending, the reaction set of the corresponding interaction element as it is. According to an embodiment, in response to the extension of the reaction set of the corresponding interaction element being determined, the processor 120 can acquire at least one reaction corresponding to a corresponding threshold range from the memory or the external device (e.g., the server or the cloud) and add the same to the reaction set of the corresponding interaction element. For example, in a state in which a reaction set for a happy emotion includes only information about a first happy reaction, the processor 120 can acquire information about a second happy reaction to the happy emotion, from the memory or the external device, and add the acquired information about the second happy reaction to the reaction set for the happy emotion, thereby extending wherein the reaction set for the happy emotion includes the information about the first happy reaction and the information about the second happy reaction. According to an embodiment, in response to a reaction set of a corresponding interaction element being extended, the processor 120 can refine a threshold range for the corresponding interaction element. For example, in response to the reaction set of the corresponding interaction element being extended on the basis of a specified first threshold range, the processor 120 can refine the threshold range of the corresponding interaction element by a specified second threshold range having a larger value than the specified first threshold range. According to an embodiment, the processor 120 can acquire a composite reaction on the basis of the frequency of use of at least two interaction elements, and add the acquired composite reaction to a reaction set of each of the two interaction elements. For example, in response to the frequency of use of a first interaction element corresponding to a first threshold range, and the frequency of use of a second interaction element corresponding to the first threshold range, the processor 120 can acquire composite reaction information related to the first threshold range of the first interaction element and the second interaction element, from the memory or the external device (e.g., the server or the cloud), and add the acquired composite reaction information to each of the reaction set of the first interaction element and the reaction set of the second interaction element.

According to various embodiments, an electronic device (e.g., the electronic device 101 of FIG. 1) can include at least one sensor (e.g., the sensor module 176, the input device 150, and/or the camera module 180 of FIG. 1), a communication module (e.g., the communication module 190 of FIG. 1) for communicating with an external device, a memory (e.g., the memory 130 of FIG. 1, and/or the internal storage 220 of FIG. 2) for storing reaction sets including at least one piece of reaction information corresponding to each of a plurality of interaction elements, and a processor (e.g., the processor 120 of FIG. 1). The processor 120 can determine an interaction element on the basis of a user's state which is obtained through the at least one sensor, offer a reaction related to the user state on the basis of a first reaction set corresponding to the determined interaction element, refine the frequency of use of the determined interaction element, and acquire at least one piece of other reaction information related to the determined interaction element from at least one of the memory or the external device on the basis of the refined use frequency and add the at least one piece of other reaction information to the first reaction set.

According to various embodiments, the interaction element can include at least one of a time element, an etiquette related element, an emotional element, a sensible element, a promise related element, or a mission related element.

According to various embodiments, in response to information about a plurality of reactions being included in the reaction set corresponding to the determined interaction element, the processor 120 can determine weights of the plurality of reactions, and determine one reaction among the plurality of reactions on the basis of the weights, and control at least one component included in the electronic device on the basis of information about the determined reaction to express the determined reaction.

According to various embodiments, the at least one component can include at least one of at least one motor (e.g., the motors 250 of FIG. 2), a display (e.g., the display 252 of FIG. 2, or the display device 160 of FIG. 1), an audio module (e.g., the audio module 170 of FIG. 1), a haptic module (e.g., the haptic module 179 of FIG. 1), a sound output device (e.g., the sound output device 155 of FIG. 1, or the speaker 254 of FIG. 2), or an illumination control device.

According to various embodiments, the weights of the plurality of reactions can be determined on the basis of a time point at which each of the plurality of reactions is added to a corresponding reaction set.

According to various embodiments, in response to the determined interaction element being a time element, the processor 120 can refine the frequency of use of the interaction element on the basis of an interaction time with a user.

According to various embodiments, in response to the determined interaction element being an etiquette related element, the processor 120 can refine the frequency of use of the interaction element on the basis of whether a specified language or behavior is sensed during an interaction with a user.

According to various embodiments, in response to the determined interaction element being an emotional element, the processor 120 can refine the frequency of use of the interaction element on the basis of a priority order of the emotional element.

According to various embodiments, in response to the determined interaction element being a sensible element, the processor 120 can refine the frequency of use of the interaction element on the basis of at least one of the type of a physical interaction sensed during an interaction with a user, a strength, a time, the number of times, an area, or an accessory.

According to various embodiments, in response to the determined interaction element being a promise related element, the processor 120 can refine the frequency of use of the interaction element on the basis of whether a specified promise has been fulfilled during an interaction with a user.

According to various embodiments, in response to the determined interaction element being a mission related element, the processor 120 can refine the frequency of use of the interaction element on the basis of the number of mission completion or the degree of difficulty during an interaction with a user.

According to various embodiments, the processor 120 can determine whether the refined use frequency corresponds to a specified threshold range, and in response to the refined use frequency corresponding to the specified threshold range, acquire at least one piece of other reaction information which is related to the determined interaction element while being related to the specified threshold range and add the acquired reaction information to the first reaction set, and in response to the refined use frequency not corresponding to the specified threshold range, maintain the first reaction set.

According to various embodiments, in response to the determined interaction element being a promise related element, the at least one piece of other reaction information can include information of at least one story content related to a promise, and the processor 120 can offer the at least one story content related to the promise added to the first reaction set, on the basis of the frequency of use of the promise related element.

According to various embodiments, in response to the determined interaction element being a mission related element, the at least one piece of other reaction information can include information of at least one content related to a mission, and the processor 120 can construct a contents map on the basis of the at least one piece of other reaction information added to the first reaction set.

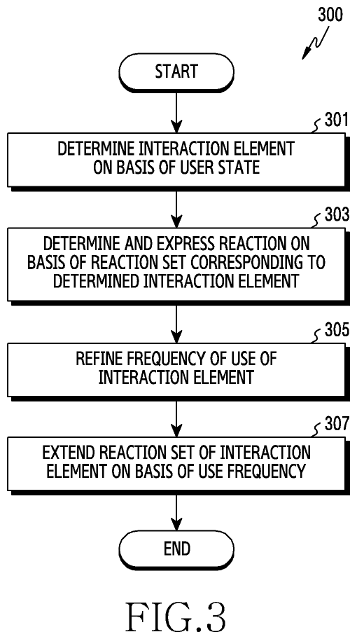

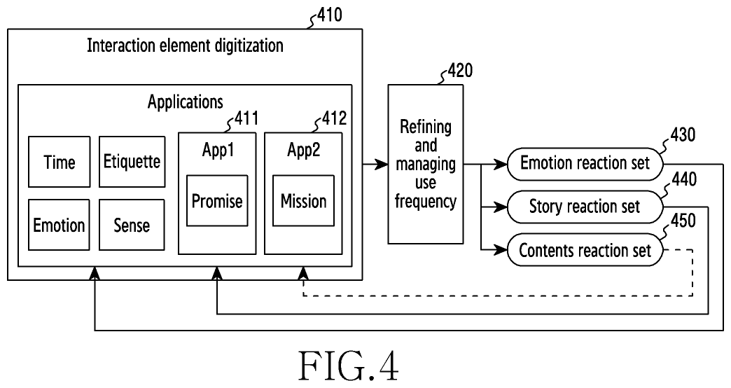

FIG. 3 is a flowchart 300 of extending a reaction set of an interaction element on the basis of a user state in an electronic device according to various embodiments. In an embodiment below, respective operations can be performed in sequence as well, but are not necessarily performed in sequence. For example, the order of the respective operations can be changed as well, and at least two operations can be performed in parallel as well. Here, the electronic device can be the electronic device 101 of FIG. 1. Below, at least a partial operation of FIG. 3 will be described with reference to FIG. 4. FIG. 4 is an example diagram of refining the frequency of use of an interaction element in the electronic device according to various embodiments.

Referring to FIG. 3, the electronic device (e.g., the processor 120 of FIG. 1) of various embodiments can, in operation 301, determine an interaction element on the basis of a user state. According to an embodiment, the processor 120 can acquire information representing a user state from at least one component (e.g., the input device 150, the sensor module 176, or the camera module 180 of FIG. 1), and determine an interaction element for offering a reaction related to the acquired user state. For example, the processor 120 can analyze a user's behavior on the basis of at least one of a voice signal (or a voice command) inputted through the input device 150, a user's face expression and/or action (body activity) inputted from the camera module 180, or user contact data acquired from the sensor module 176, and determine an interaction element for offering a reaction related to a user state on the basis of the analysis result. For example, the processor 120 can determine whether to offer a reaction related to which interaction element among various interaction elements on the basis of the user's behavior analysis result. The interaction element, for example, can include at least one of a temporal element, an etiquette related element, an emotional element, a sensible element, a promise related element, or a mission related element. This is exemplary, and various embodiments of the present disclosure would not be limited to this. For instance, in response to it being analyzed that a user is crying, the processor 120 can determine a sad emotion element as the interaction element wherein a reaction related to a sad emotion is offered. For another example, in response to it being analyzed that the user is performing amusement according to a specified schedule, the processor 120 can determine the temporal element and/or the promise related element as the interaction element wherein a reaction related to a time and/or a promise is offered. For further example, in response to it being analyzed that the user utters a word related to etiquette or performs an action related to the etiquette, the processor 120 can determine the etiquette related element as the interaction element wherein a reaction related to the etiquette is offered. For yet another example, in response to it being analyzed that the user is performing a specified mission, the processor 120 can determine the mission element as the interaction element wherein a reaction related to mission execution is offered.

According to various embodiments, the electronic device (e.g., the processor 120) can, in operation 303, determine a reaction on the basis of a reaction set corresponding to the determined interaction element, and control at least one component wherein the determined reaction is expressed. According to an embodiment, the processor 120 can confirm a reaction DB corresponding to a corresponding user, on the basis of identification information of the corresponding user from a storage (e.g., the memory 130 or the internal storage 220) of the electronic device 101, and acquire a reaction set corresponding to the determined interaction element within the confirmed reaction DB. The processor 120 can determine a reaction which will be offered to the user among at least one reaction included in the acquired reaction set. The identification information of the user can be acquired on the basis of a voice signal of the user, an image including a user's face, or a user's contact to the electronic device. According to an embodiment, in response to a plurality of reactions being included in the reaction set corresponding to the determined interaction element, the processor 120 can select one reaction among the plurality of reactions on the basis of weights of the plurality of reactions. According to an embodiment, the weight of each of the plurality of reactions can be set and/or changed by a designer and/or a user. According to an embodiment, the processor 120 can control at least one component (e.g., the sound output device 155, the haptic module 179, the display device 160, or the behavior module 163) included in the electronic device 101 on the basis of the determined reaction, thereby offering the determined reaction to the user. For example, in response to the determined interaction element being a happy emotion related element, the processor 120 can determine a first happy reaction in a reaction set corresponding to the happy emotion element and, on the basis of information representing the first happy reaction, the processor 120 can control at least one of the motors 250, the display 252, or the speaker 254 included in the electronic device 101 and express the first happy reaction. For another example, in response to the determined interaction element being a promise related element, the processor 120 can select the most recently added story contents in a reaction set corresponding to the promise related element, and control at least one of the motors 250, the display 252, or the speaker 254 included in the electronic device 101 and offer the selected story contents.

According to various embodiments, the electronic device (e.g., the processor 120) can, in operation 305, refine the frequency of use of the determined interaction element. According to an embodiment, the electronic device can determine a change numerical value for the frequency of use of the determined interaction element, and refine the use frequency on the basis of the determined change numerical value. For example, as illustrated in FIG. 4, the processor 120 can digitize (410) at least one interaction element among various interaction elements by using a plurality of applications, and refine and manage (420) a use frequency. For instance, the processor 120 can sense offering a reaction related to interaction elements such as a time, etiquette, an emotion, a sense, a promise, and/or a mission by using a plurality of application programs installed in the electronic device 101, and determine a change numerical value for refining the frequency of use of the interaction element related to the offered reaction. The offering or non-offering of the reaction related to the interaction elements such as the time, the etiquette, the emotion, and/or the sense is possible to be sensed through all application programs installed in the electronic device 101, and the offering or non-offering of the reaction related to some interaction elements such as the promise and/or the mission can be sensed through a specific application program. For instance, the offering or non-offering of the reaction of the promise related element can be sensed through a first application program for registering and managing a promise between a user (e.g., a child) and another user (e.g., a parent), and the offering or non-offering of the reaction of the mission related element can be sensed through a second application program for managing amusement and/or learning contents. According to an embodiment, a change numerical value for refining the frequency of use of an interaction element can be determined in another scheme in accordance with the interaction element.

According to various embodiments, the electronic device (e.g., the processor 120) can, in operation 307, extend a reaction set of a corresponding interaction element on the basis of the refined use frequency. According to an embodiment, the processor 120 can extend a reaction set of an interaction element on the basis of the frequency of use of the interaction element. According to an embodiment, the processor 120 can, after refining the frequency of use of the interaction element, determine whether to extend a reaction set of the corresponding interaction element on the basis of whether the refined use frequency corresponds to a threshold range. For example, in response to the refined use frequency corresponding to a specified first threshold range (e.g., second threshold>use frequency>first threshold), the processor 120 can determine the extension of the reaction set of the corresponding interaction element and, in response to the refined use frequency not corresponding to the specified first threshold range (e.g., use frequency<first threshold), the processor 120 can determine to maintain, without extending, the reaction set of the corresponding interaction element as it is. According to an embodiment, in response to the extension of the reaction set of the corresponding interaction element being determined, the processor 120 can acquire at least one reaction corresponding to a corresponding threshold range from a memory or an external device (e.g., a server or a cloud) and add the same to the reaction set of the corresponding interaction element. For example, as illustrated in FIG. 4, in response to the frequency of use of a specific emotion corresponding to a first threshold range, the processor 120 can acquire a reaction to the specific emotion and add the same to a reaction set 430 for the specific emotion. For another example, as illustrated in FIG. 4, in response to the frequency of use of a promise related element corresponding to the first threshold range, the processor 120 can acquire a reaction (e.g., story contents) to the promise related element and add the same to a story reaction set 440 related to a promise. For further example, as illustrated in FIG. 4, in response to the frequency of use of a mission related element corresponding to the first threshold range, the processor 120 can acquire a reaction (e.g., amusement contents or learning contents corresponding to a next mission) to the mission related element and add the same to a contents reaction set 450 related to a mission. According to an embodiment, the contents reaction set can include a contents map representing information about at least one of mission completion contents, contents corresponding to a next mission, and/or contents impossible to be currently offered. According to an embodiment, in response to a reaction set of a corresponding interaction element being extended, the processor 120 can refine a threshold range for the corresponding interaction element. For example, in response to the reaction set of the corresponding interaction element being extended on the basis of a specified first threshold range, the processor 120 can refine a threshold range of the corresponding interaction element as a specified second threshold range having a larger value than the specified first threshold range, thereby controlling wherein, in response to the frequency of use of the corresponding interaction element corresponding to the refined threshold range, the reaction set of the corresponding interaction element is additionally extended.

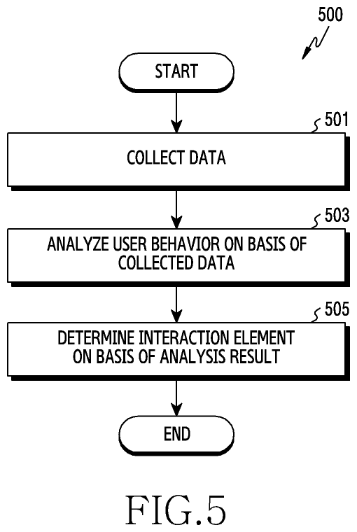

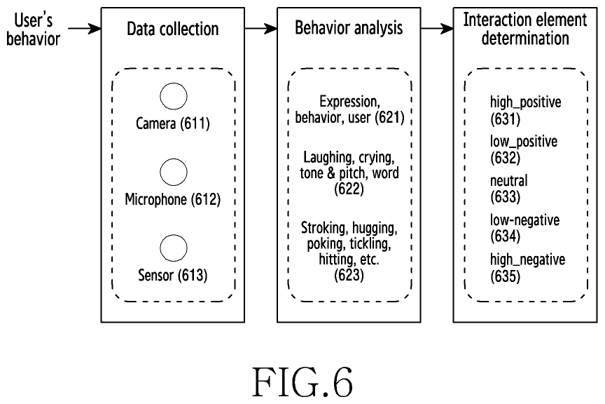

FIG. 5 is a flowchart 500 of determining an interaction element in an electronic device according to various embodiments. Operations of FIG. 5 below can be at least part of a detailed operation of operation 301 of FIG. 3. In an embodiment below, respective operations can be performed in sequence as well, but are not necessarily performed in sequence. For example, the order of the respective operations can be changed as well, and at least two operations can be performed in parallel as well. Here, the electronic device can be the electronic device 101 of FIG. 1. Below, at least a partial operation of FIG. 5 will be described with reference to FIG. 6. FIG. 6 is an example diagram of determining an interaction element on the basis of a user behavior in the electronic device according to various embodiments.

Referring to FIG. 5, the electronic device (e.g., the processor 120 of FIG. 1) of various embodiments can, in operation 501, collect data related to a user state. According to an embodiment, the processor 120 can collect the data related to the user state by using at least one component (e.g., the input device 150, the sensor module 176, or the camera module 180). For example, the processor 120 can collect the data related to the user state by using at least one of a visual sensing device, an auditory sensing device, a tactile sensing device, or other data sensing device. The visual sensing device, for example, can include at least one of the 2D camera 182 or the depth camera 184. The auditory sensing device, for example, can include a microphone. The tactile sensing device, for example, can include a touch sensor, a vibration sensor, a proximity detector, a pressure sensor, a force sensor, or a distance sensor. The other data sensing device can include at least one of a position detecting device, a laser scanner, or a radar sensor. For example, as illustrated in FIG. 6, the processor 120 can collect visual data through the camera 611, and collect auditory data through the microphone 612, and collect tactile data and/or other data through the sensors 613.

According to various embodiments, the electronic device (e.g., the processor 120) can, in operation 503, analyze a user behavior on the basis of the collected data. According to an embodiment, the processor 120 can analyze the user behavior on the basis of at least one of the visual data, the auditory data, the tactile data, or the other data acquired from the at least one component. For example, as illustrated in FIG. 6, the processor 120 can analyze the visual data collected through the camera 611 and acquire information about a user expression, information about a user behavior (e.g., a posture, an action, a motion, a gesture), and user identification information 621. For another example, as illustrated in FIG. 6, the processor 120 can analyze the auditory data collected through the microphone 612 and acquire information 622 about a laugh, crying, a voice tone, a voice pitch, or a word. For further example, as illustrated in FIG. 6, the processor 120 can analyze the tactile data and the other data collected through the sensors 613, and acquire information 623 representing whether a user behavior accompanying a physical contact to the electronic device 101 corresponds to which behavior among stroking, hugging, poking, tapping, tickling, or hitting.

According to various embodiments, the electronic device (e.g., the processor 120) can, in operation 505, determine an interaction element on the basis of the analysis result. According to an embodiment, the processor 120 can determine an interaction element for offering a reaction related to a user state, on the basis of the user behavior analysis result. For example, the processor 120 can determine a user's emotion state on the basis of the user behavior analysis result, and determine the determined emotion state as the interaction element. For instance, as illustrated in FIG. 6, the processor 120 can divide the user emotion state into types of high_positive (631), low_positive (632), neutral (633), low_negative (634), and high_negative (635), and determine whether the user's emotion state corresponds to which type on the basis of the user behavior analysis result. For example, in response to a laughing expression, a laughing sound, and a tapping behavior being sensed as the user behavior analysis result, the processor 120 can determine the user emotion state as high_positive, and determine the interaction element as high_positive or determine the same as a happy emotion corresponding to high_positive. For another example, in response to a crying expression, a crying sound, and a hugging behavior being sensed as the user behavior analysis result, the processor 120 can determine the user emotion state as low_negative, and determine the interaction element as low_negative or determine the same as a sad emotion corresponding to low_negative. For further example, in response to a word related learning and a posture of sitting at one's desk being sensed as the user behavior analysis result, the processor 120 can determine that a user is learning and determine the interaction element as a time. For yet another example, in response to a behavior (e.g., eating vegetables, brushing one's teeth, etc.) related to a specified promise being sensed as the user behavior analysis result, the processor 120 can determine the interaction element as a promise related element. For still another example, in response to a behavior (e.g., singing, foreign-language learning amusement, five-sense development amusement, etc.) of executing a mission of specific amusement contents being sensed as the user behavior analysis result, the processor 120 can determine the interaction element as a mission related element.

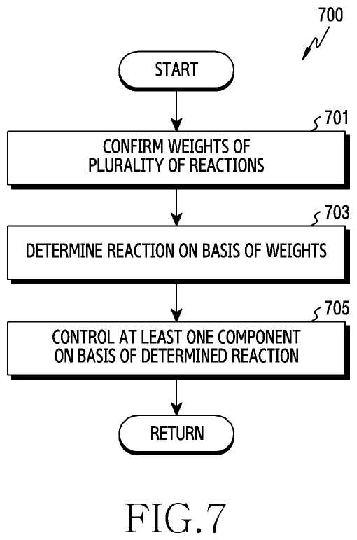

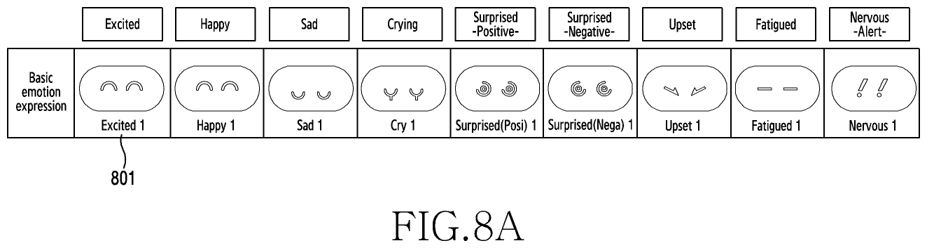

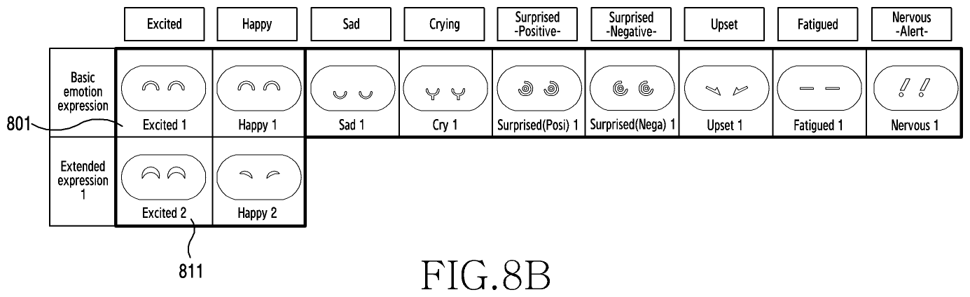

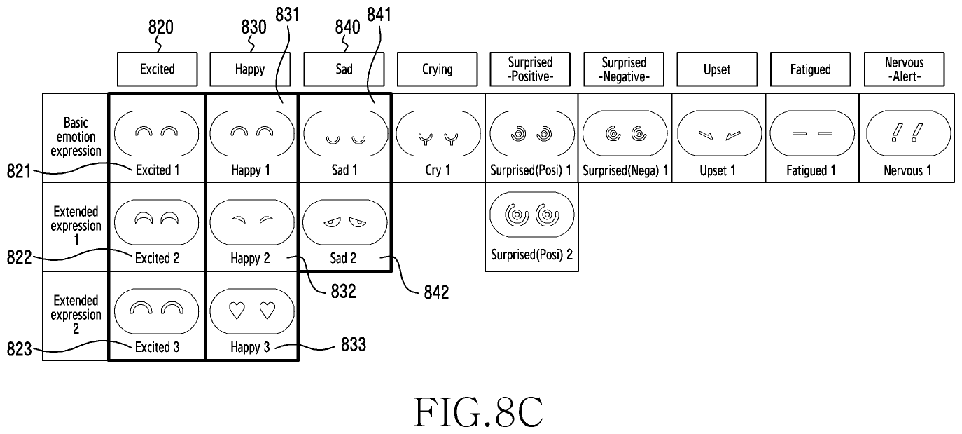

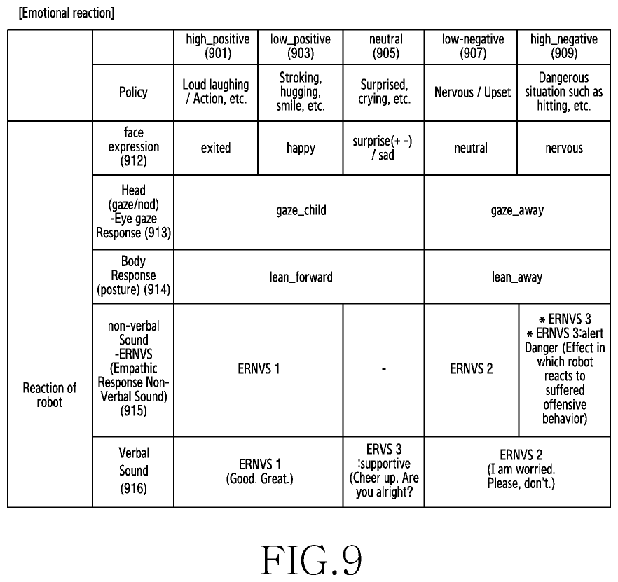

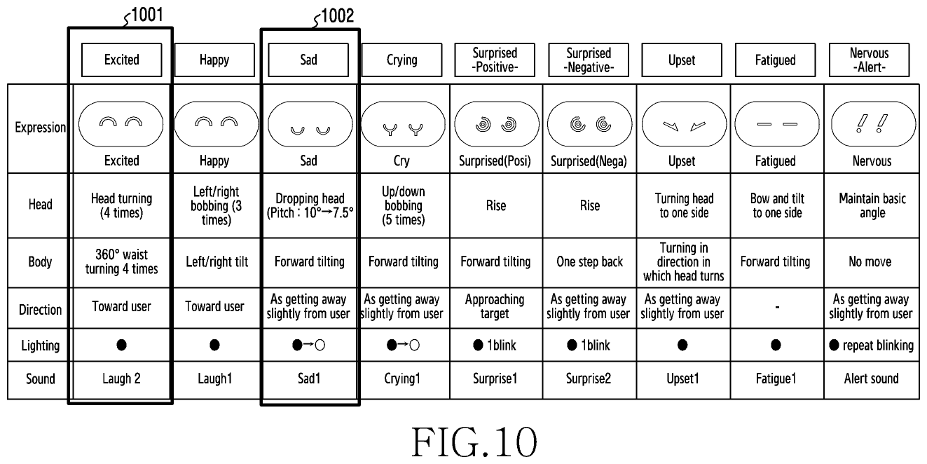

FIG. 7 is a flowchart 700 of offering a reaction of an interaction element in an electronic device according to various embodiments. Operations of FIG. 7 below can be at least part of a detailed operation of operation 303 of FIG. 3. In an embodiment below, respective operations can be performed in sequence as well, but are not necessarily performed in sequence. For example, the order of the respective operations can be changed as well, and at least two operations can be performed in parallel as well. Here, the electronic device can be the electronic device 101 of FIG. 1. Below, at least a partial operation of FIG. 7 will be described with reference to FIG. 8A to FIG. 10. FIG. 8A to FIG. 8C are example diagrams showing a reaction set associated with a use frequency for each emotion according to various embodiments. FIG. 9 is an example diagram showing a reaction for each emotion associated with a user state in the electronic device according to various embodiments, and FIG. 10 is an example diagram for a reaction offered by emotion in the electronic device according to various embodiments.

Referring to FIG. 7, the electronic device (e.g., the processor 120 of FIG. 1) of various embodiments can, in operation 701, confirm weights of a plurality of reactions within a reaction set of a determined interaction element. According to an embodiment, the processor 120 can acquire a reaction set corresponding to the interaction element determined through operation 301 of FIG. 3 or operation 505 of FIG. 5. For example, as described in operation 303 of FIG. 3, the processor 120 can acquire the reaction set corresponding to the determined interaction element. In response to the plurality of reactions being included within the reaction set of the determined interaction element, the processor 120 can determine and/or confirm a weight of each of the plurality of reactions. According to an embodiment, the processor 120 can determine the weight of each of the plurality of reactions on the basis of a time point at which each reaction is added to a corresponding reaction set. For example, referring to FIG. 8A and FIG. 8B, in response to a first excited reaction (Excited 1) 801 being included in a reaction set of an excited emotion at a first time point, and a second excited reaction (Excited 2) 811 being added to the corresponding reaction set as the frequency of use of the excited emotion increases at a second time point, the processor 120 can determine a weight of the first excited reaction 801 lower than a weight of the second excited reaction 811. For example, the processor 120 can determine the weight of the first excited reaction 801 as 0.3, and the weight of the second excited reaction 811 as 0.7. According to an embodiment, at a time point at which the reaction set corresponding to the determined interaction element is extended, the processor 120 can determine and/or change a weight of each of a plurality of reactions included in the extended reaction set. According to an embodiment, the processor 120 can determine the weight of each of the plurality of reactions on the basis of whether the corresponding interaction element is an element related to an emotion expression disposition of the electronic device 101. For example, in response to a main expression emotion of the electronic device 101 being a happy emotion, the processor 120 can determine a weight of each of a plurality of reactions included in a reaction set corresponding to the happy emotion as a mutually different value, and can determine a weight of each of a plurality of reactions included in a reaction set corresponding to other emotion besides this as a mutually identical value. For example, as illustrated in FIG. 8C, in response to a reaction set 820 of an excited emotion and a reaction set 830 of a happy emotion being most extended to include the most reactions, the processor 120 can determine that the main expression emotions are the excited emotion and the happy emotion. The processor 120 can determine a weight of each of a first excited reaction 821, a second excited reaction 822, and a third excited reaction 823 included in the reaction set 820 of the excited emotion as 0.1, 0.3, and 0.6, and can determine a weight of each of a first excited reaction 831, a second excited reaction 832, and a third excited reaction 833 included in the reaction set 830 of the happy emotion as 0.1, 0.3, and 0.6. The processor 120 can determine a weight of each of a first sad emotion 841 and a second sad emotion 842 included in a reaction set 840 of a sad emotion, not the main expression emotion, as 0.5 and 0.5. According to an embodiment, the processor 120 can change a weight of each of a plurality of reactions included in at least one reaction set at a time point at which the reaction set corresponding to the determined interaction element is extended, and/or a time point at which the main expression emotion of the electronic device 101 is changed. The aforementioned scheme of determining the weight is exemplary, and the present disclosure is not limited to this.

According to various embodiments, the electronic device (e.g., the processor 120) can, in operation 703, determine a reaction which will be offered to a user on the basis of the weight. According to an embodiment, the processor 120 can determine the reaction which will be offered to the user, wherein a reaction having the highest weight among a plurality of reactions included in a reaction set is most offered to the user, and a reaction having the lowest weight among the plurality of reactions is least offered to the user. For example, the processor 120 can determine the reaction which will be offered to the user, on the basis of the weight of each of the plurality of reactions and the number of offering (or the number of selection or the number of expression) of each of the plurality of reactions. According to an embodiment, each reaction can include at least one of expression data, data representing a movement (or an action) of a specific component (e.g., a head, a body, an arm, and/or a leg) of the electronic device, data representing a moving direction, data representing a movement speed, data representing the magnitude of a movement, data related to the output of a display, illumination control data, sound related data, or data about suppliable contents. For example, as illustrated in FIG. 9, reactions to emotional elements 901, 903, 905, 907, and 909 can include at least one of face expression data 912, movement data 913 of a head related to a gaze, body movement data 914, non-verbal sound data 915, or verbal sound data 916.

According to various embodiments, the electronic device (e.g., the processor 120) can, in operation 705, control at least one component on the basis of the determined reaction. According to an embodiment, the processor 120 can control at least one component (e.g., the sound output device 155, the haptic module 179, the display device 160, or the behavior module 163) included in the electronic device 101 on the basis of the determined reaction, thereby offering the determined reaction to a user. For example, as illustrated in FIG. 10, in response to a first excited reaction (Excited 1) 1001 included in a reaction set for an excited emotion being determined, the processor 120 can control at least one of the motors 250, the display 252, the speaker 254, and the illumination control device wherein the electronic device 101 gives a laughing expression towards the user while making head turning 4 times and 360° waist turning 4 times, and turns on a light and outputs a specified second laughing sound. For another example, as illustrated in FIG. 10, in response to a first sad reaction (Sad 1) 1011 included in a reaction set for a sad emotion being determined, the processor 120 can control at least one of the motors 250, the display 252, or the speaker 254 wherein the electronic device 101 gets away slightly from a user with a crying expression while bending the body forward with a bowed head, and outputs a specified first sad sound and gradually decreases illumination.

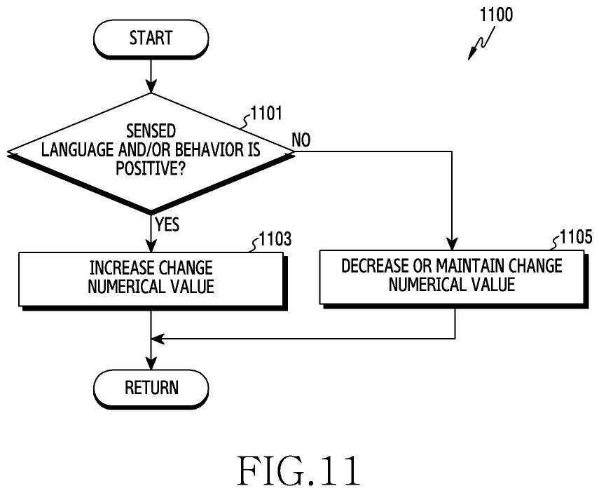

FIG. 11 is a flowchart 1100 of digitizing the frequency of use of an interaction element related to etiquette in an electronic device according to various embodiments. Operations of FIG. 11 below can be at least part of a detailed operation of operation 305 of FIG. 3. In an embodiment below, respective operations can be performed in sequence as well, but are not necessarily performed in sequence. For example, the order of the respective operations can be changed as well, and at least two operations can be performed in parallel as well. Here, the electronic device can be the electronic device 101 of FIG. 1. FIG. 11 below is a description for a case that a determined interaction element is an etiquette related element.

Referring to FIG. 11, the electronic device (e.g., the processor 120 of FIG. 1) of various embodiments can, in operation 1101, determine whether a sensed language and/or behavior (e.g., a posture, a motion, or an action) is positive. For example, in response to the determined interaction element being an etiquette related element, the processor 120 can sense a language and/or behavior related to etiquette during an interaction with a user. The processor 120 can determine whether the language and/or behavior related to the etiquette sensed during the interaction with the user is a positive language and/or behavior. For instance, the processor 120 can determine whether a positive word (e.g., a word expressing a gratitude, a word expressing a favor, etc.) being a well-mannered expression is sensed from user utterance during the interaction with the user, or whether a negative word (e.g., a word of abuse) being an ill-mannered expression is sensed. In another example, the processor 120 can determine whether a positive action (e.g., an action of bowing, etc.) being a user's well-mannered expression is sensed during the interaction with the user, or a negative action being an ill-mannered expression is sensed. According to an embodiment, a positive language (or word), a positive behavior, a well-mannered expression (or word), and/or a well-mannered action can be set and/or changed by a designer and/or a user. For example, a parent user of the electronic device 101 can directly input a word such as Thank you, Do me a favor, I love you, etc. as a well-mannered expression to the electronic device 101 and set the same as a positive language, in order to make a well-mannered behavior of a child user as part of daily life. According to an embodiment, a negative language, a negative behavior, an ill-mannered word, and/or an ill-mannered action can be set and/or changed by a designer and/or a user. For example, the parent user of the electronic device 101 can directly input a word representing a word of abuse as an ill-mannered expression to the electronic device 101 and set the same as a negative language, in order to make the well-mannered behavior of the child user as part of daily life.

According to various embodiments, in response to the sensed language and/or behavior being positive, the electronic device (e.g., the processor 120) can, in operation 1103, determine a numerical value increase for a use frequency. For example, the processor 120 can determine a numerical value increase for a use frequency, and determine a change numerical value for the use frequency as +α. According to an embodiment, the processor 120 can determine to increase the change numerical value in proportion to the number of positive words and/or the number of action sensing. For example, in response to an N number of positive words being sensed, the processor 120 can determine the change numerical value for the use frequency as +Nα. According to an embodiment, the processor 120 can refine the frequency of use of an etiquette related element on the basis of the determined change numerical value.

According to various embodiments, in response to the sensed language and/or behavior being negative, not positive, the electronic device (e.g., the processor 120) can, in operation 1105, determine a numerical value decrease or maintenance for the use frequency. For example, the processor 120 can determine the numerical value decrease or maintenance for the use frequency, and determine the change numerical value for the use frequency as −α or 0. According to an embodiment, the processor 120 can determine to decrease the change numerical value in proportion to the number of negative words and/or the number of action sensing. For example, in response to an N number of negative words being sensed, the processor 120 can determine the change numerical value for the use frequency as −Nα. According to an embodiment, the processor 120 can refine the frequency of use of an etiquette related element on the basis of the determined change numerical value.

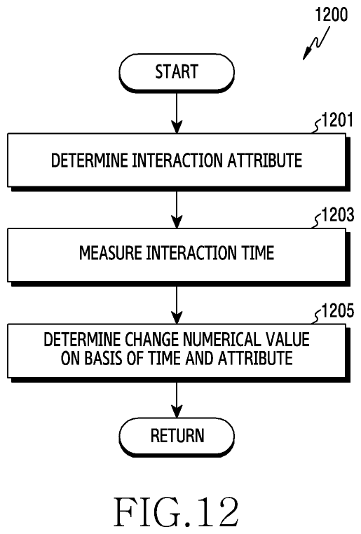

FIG. 12 is a flowchart 1200 of digitizing the frequency of use of an interaction element related to a time in an electronic device according to various embodiments. Operations of FIG. 12 below can be at least part of a detailed operation of operation 305 of FIG. 3. In an embodiment below, respective operations can be performed in sequence as well, but are not necessarily performed in sequence. For example, the order of the respective operations can be changed as well, and at least two operations can be performed in parallel as well. Here, the electronic device can be the electronic device 101 of FIG. 1. FIG. 12 below is a description for a case that a determined interaction element is a time related element.

Referring to FIG. 12, the electronic device (e.g., the processor 120 of FIG. 1) of various embodiments can, in operation 1201, determine an interaction attribute. According to an embodiment, in response to the determined interaction element being a time related element, the interaction attribute can include at least one of amusement, learning, or talking. For example, the processor 120 can determine whether it is playing amusement with a user, whether it is learning, or whether it is talking.

According to various embodiments, the electronic device (e.g., the processor 120) can, in operation 1203, measure an interaction time. For example, the processor 120 can measure the interaction time with the user. For instance, the processor 120 can measure an amusement time, a learning time, or a talking time that the electronic device 101 has with the user.

According to various embodiments, the electronic device (e.g., the processor 120) can, in operation 1205, determine a change numerical value on the basis of the attribute and the time. For example, in response to the interaction attribute and time being confirmed as learning and 10 minutes, the processor 120 can determine a change numerical value for a use frequency as a*m and, in response to the interaction attribute and time being confirmed as learning and N*10 minutes, the processor 120 can determine the change numerical value for the use frequency as a*Nm. For another example, in response to the interaction attribute and time being confirmed as amusement and 1 hour, the processor 120 can determine the change numerical value for the use frequency as b*m and, in response to the interaction attribute and time being confirmed as amusement and N hours, the processor 120 can determine the change numerical value for the use frequency as b*Nm. According to an embodiment, the processor 120 can refine the frequency of use of the time related element on the basis of the determined change numerical value.

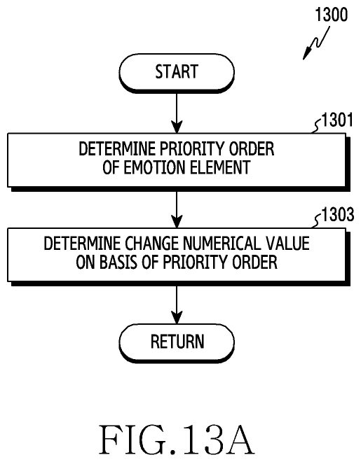

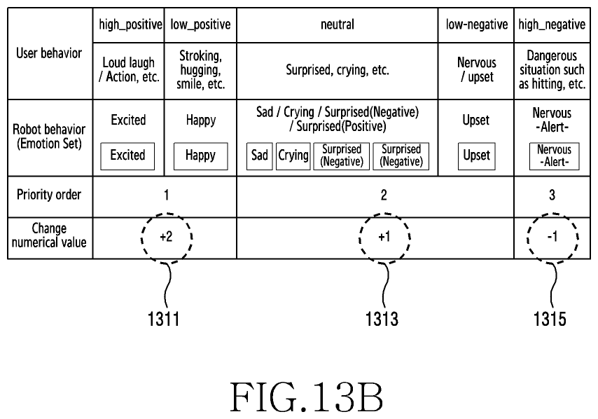

FIG. 13A is a flowchart 1300 of digitizing the frequency of use of an interaction element related to an emotion in an electronic device according to various embodiments. Operations of FIG. 13A below can be at least part of a detailed operation of operation 305 of FIG. 3. In an embodiment below, respective operations can be performed in sequence as well, but are not necessarily performed in sequence. For example, the order of the respective operations can be changed as well, and at least two operations can be performed in parallel as well. Here, the electronic device can be the electronic device 101 of FIG. 1. FIG. 13A below is a description for a case that a determined interaction element is an emotional element. Below, at least a partial operation of FIG. 13A will be described with reference to FIG. 13B. FIG. 13B is an example diagram of digitizing the frequency of use of the interaction element related to the emotion in the electronic device according to various embodiments.

Referring to FIG. 13A, the electronic device (e.g., the processor 120 of FIG. 1) of various embodiments can, in operation 1301, determine a priority order of an emotion element. According to an embodiment, a priority order of each emotion element can be determined and/or changed on the basis of the number of expressing a reaction of a corresponding emotion, and/or user setting. For example, in response to the accumulated number of expressing a reaction of a happy emotion being 100 times, and the accumulated number of expressing a reaction of a sad emotion being 15 times, and the accumulated number of expressing a reaction of a high-negative emotion being 5 times, a priority order of the happy emotion can be set as a number one order, and a priority order of the sad emotion can be set as a number two order, and a priority order of the high-negative emotion can be set as a number three order. For another example, irrespective of the number of expression, on the basis of a user request, a priority order of an excited emotion can be set as a number one order, the priority order of the happy emotion can be set as a number two order, and a priority order of a depressive emotion can be set as a number three order. For example, a parent user of the electronic device 101 can set the priority order of the excited emotion or the happy emotion higher, in order to lead a child user to much perform a positive emotion expression.

According to various embodiments, the electronic device (e.g., the processor 120) can, in operation 1303, determine a change numerical value on the basis of the priority order. For example, the processor 120 can determine the change numerical value wherein a use frequency increases by a wide range as the priority order is higher, and determine the change numerical value wherein the use frequency increases by a narrow range or decreases by a wide range as the priority order is lower. For example, as illustrated in FIG. 13B, the processor 120 can determine that a change numerical value for a use frequency of high_positive and low_positive whose priority order is a number one order becomes +2 (1311), and a change numerical value for a use frequency of neutral and low_negative whose priority order is a number two order becomes +1 (1313), and a change numerical value for a use frequency of high_negative whose priority order is a number three order becomes −1 (1315). According to an embodiment, the processor 120 can refine the frequency of use of a corresponding emotion element on the basis of the determined change numerical value.

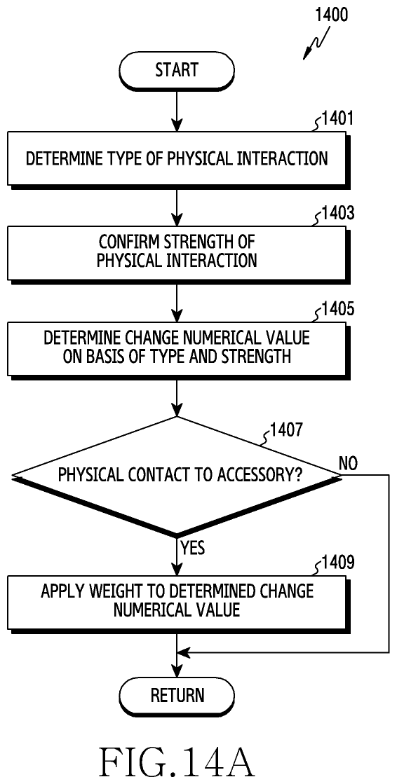

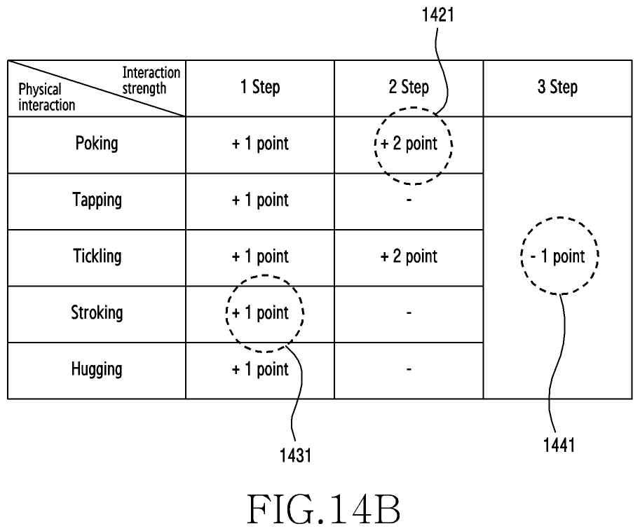

FIG. 14A is a flowchart 1400 of digitizing the frequency of use of an interaction element related to a sense in an electronic device according to various embodiments. Operations of FIG. 14A below can be at least part of a detailed operation of operation 305 of FIG. 3. In an embodiment below, respective operations can be performed in sequence as well, but are not necessarily performed in sequence. For example, the order of the respective operations can be changed as well, and at least two operations can be performed in parallel as well. Here, the electronic device can be the electronic device 101 of FIG. 1. FIG. 14A below is a description for a case that a determined interaction element is a sensible element. Below, at least a partial operation of FIG. 14A will be described with reference to FIG. 14B. FIG. 14B is an example diagram of digitizing the frequency of use of the interaction element related to the sense in the electronic device according to various embodiments.

Referring to FIG. 14A, the electronic device (e.g., the processor 120 of FIG. 1) of various embodiments can, in operation 1401, determine the type (or kind) of a physical interaction. According to an embodiment, in response to the determined interaction element being a sensible element, the processor 120 can determine the type of an interaction sensed physically through at least one sensor (e.g., the sensor module 176 of FIG. 1). For example, the processor 120 can determine the type of the physical interaction, on the basis of a touch sensing position, the number of times, an area, and/or a time acquired through at least one touch sensor installed in the electronic device 101. The type of the physical interaction, for example, can include at least one of a poking type, a tapping type, a tickling type, a stroking type, or hugging. For instance, in response to a touch area being smaller than a first specified threshold area, and a touch time being shorter than a first specified threshold time, and the number of touches being greater than or being equal to a first specified threshold number of times, the processor 120 can determine the type of an interaction as the tapping type. In response to a touch being maintained during a second specified threshold time or more while a touch sensing position being changed, and the number of touch sensing being greater than or being equal to a second specified threshold number of times, the processor 120 can determine the interaction type as the stroking type. In response to the touch area being greater than a second threshold area, and a touch being maintained during a third specified threshold time or more, the processor 120 can determine the interaction type as the hugging type.

According to various embodiments, the electronic device (e.g., the processor 120) can, in operation 1403, confirm a strength (or intensity) of the physical interaction. According to an embodiment, the processor 120 can determine an expression strength for an interaction sensed physically through at least one sensor (e.g., the sensor module 176 of FIG. 1). For example, the processor 120 can measure a pressure of an interaction through a pressure sensor, and determine an expression strength of the interaction on the basis of the measured pressure. For another example, the processor 120 can determine the expression strength of the interaction, on the basis of an area size for the interaction and the number of repetition through a touch sensor.

According to various embodiments, the electronic device (e.g., the processor 120) can, in operation 1405, determine a change numerical value for a use frequency on the basis of the confirmed type and strength. According to an embodiment, the processor 120 can determine the change numerical value for the frequency of use of a corresponding interaction element on the basis of a previously stored table representing the change numerical value associated with the type and strength. For example, as illustrated in FIG. 14B, in response to the type of the interaction being a stroking type, and the expression strength of the interaction corresponding to step 1, the processor 120 can determine a change numerical value for the frequency of use of a stroking interaction element, as +1 (1431). For another example, in response to the type of the interaction being a poking type, and the expression strength of the interaction corresponding to step 2, the processor 120 can determine a change numerical value for the frequency of use of a poking interaction element, as +2 (1421). For further example, in response to the expression strength of the interaction corresponding to step 3, the processor 120 can determine a change numerical value for the frequency of use of a corresponding interaction element, as −1 (1441), regardless of the type of the interaction.

According to various embodiments, the electronic device (e.g., the processor 120) can, in operation 1407, determine whether the physical interaction is a physical contact to an accessory. For example, the processor 120 can determine whether the physical interaction is a physical interaction for the accessory installed in the electronic device 101.

According to various embodiments, in response to being the physical interaction for the accessory, the electronic device (e.g., the processor 120) can, in operation 1409, apply a weight to the determined change numerical value. For example, in response to the physical interaction being for the accessory, and the change numerical value determined in operation 1405 being +2, the processor 120 can apply a weight and determine the change numerical value as +4. For another example, in response to the physical interaction being for the accessory, and the change numerical value determined in operation 1405 being +1, the processor 120 can apply a weight and determine the change numerical value as +2. According to an embodiment, the weight can be set differently by accessory on the basis of an installation position of the accessory. For example, the processor 120 can determine a weight of an accessory installed in a head portion of the electronic device 101, as three times, and determine a weight of an accessory installed in a body portion, as two times. According to an embodiment, a weight of each of accessories can be set and/or changed by a designer and/or a user. According to an embodiment, the processor 120 can refine the frequency of use of a corresponding sensible element on the basis of the determined change numerical value.

The aforementioned scheme of digitizing the frequency of use of the interaction element related to the sense of FIG. 14A and FIG. 14B is an example for helping the understanding of the present disclosure, and various embodiments of the present disclosure would not be limited to this. For example, the electronic device 101 can determine a change numerical value wherein a rise range of the frequency of use of a corresponding interaction element is increased as an expression time of a physical interaction is longer, or as a contact area of the physical interaction is wider. For instance, in response the expression time of the physical interaction being shorter than a first specified expression time, the electronic device 101 can determine the change numerical value as a and, in response to the expression time of the physical interaction being longer than the first specified expression time and being shorter than a second specified expression time, the electronic device 101 can determine the change numerical value as b and, in response to the expression time of the physical interaction being longer than the second specified expression time and being shorter than a third specified expression time, the electronic device 101 can determine the change numerical value as c. Here, the a, b, and c can satisfy the condition of a<b<c.

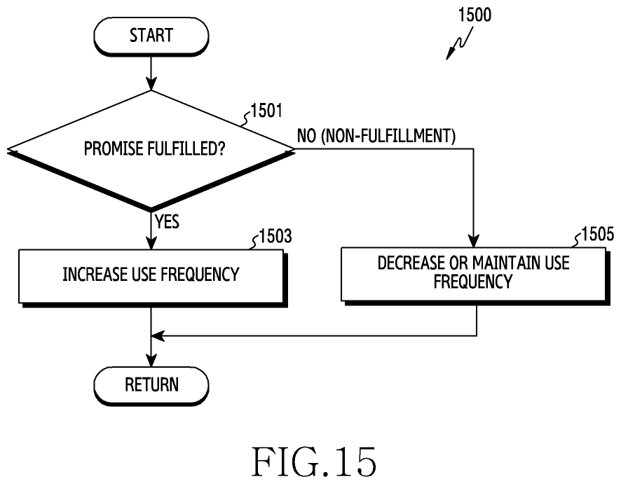

FIG. 15 is a flowchart 1500 of digitizing the frequency of use of an interaction element related to a promise in an electronic device according to various embodiments. Operations of FIG. 15 below can be at least part of a detailed operation of operation 305 of FIG. 3. FIG. 15 below is a description for a case that a determined interaction element is a promise related element. In an embodiment below, respective operations can be performed in sequence as well, but are not necessarily performed in sequence. For example, the order of the respective operations can be changed as well, and at least two operations can be performed in parallel as well. Here, the electronic device can be the electronic device 101 of FIG. 1.

Referring to FIG. 15, the electronic device (e.g., the processor 120 of FIG. 1) of various embodiments can, in operation 1501, determine whether a specified promise has been fulfilled. For example, the processor 120 can determine whether a previously registered or specified promise has been fulfilled by a user. According to an embodiment, the promise can be previously registered or specified by the user (e.g., a child and/or a parent). For example, the parent user can previously register a promise (e.g., eating vegetables, brushing one's teeth within 3 minutes after meal, or arranging toys, etc.) for a good daily habit of the child user, to the electronic device 101. According to an embodiment, the processor 120 can previously acquire information about a promise from an external electronic device (e.g., the electronic device 102, the electronic device 104, or the server 108) by using a specified application, and register information about at least one promise on the basis of the acquired information.

According to various embodiments, in response to the promise having been fulfilled, the electronic device (e.g., the processor 120 of FIG. 1) can, in operation 1503, determine a numerical value increase for the frequency of use of a promise related element. For example, in response to the promise having been fulfilled, the processor 120 can determine a change numerical value as +i, wherein a numerical value for the frequency of use of the promise related element is increased. According to an embodiment, the change numerical value for a case that the promise has been fulfilled can be determined differently by promise. For example, the user (e.g., the child and/or the parent) can set and/or change, for at least one promise, a change numerical value for a case that the corresponding promise has been fulfilled. For instance, on the basis of a parent user's input, the processor 120 can determine a change numerical value for the fulfillment of a first promise as +3, and determine a change numerical value for the fulfillment of a second promise as +1. According to an embodiment, in response to at least one promise having been fulfilled, the processor 120 can increase the numerical value for the frequency of use of the promise related element, on the basis of the change numerical value previously set for the fulfillment of the corresponding promise.

According to various embodiments, in response to the promise not having been fulfilled, the electronic device (e.g., the processor 120 of FIG. 1) can, in operation 1505, determine a numerical value decrease or maintenance for the frequency of use of the promise related element. For example, in response to the promise not having been fulfilled, the processor 120 can determine the change numerical value as −i or 0, wherein a numerical value for the frequency of use of the promise related element is decreased. According to an embodiment, the change numerical value for a case that the promise has not been fulfilled can be determined differently by promise. For example, the user (e.g., the child and/or the parent) can set and/or change, for at least one promise, a change numerical value for a case that the corresponding promise has not been fulfilled. For instance, on the basis of a parent user's input, the processor 120 can determine a change numerical value for the non-fulfillment of a first promise as −3, and determine a change numerical value for the non-fulfillment of a second promise as −1. According to an embodiment, in response to at least one promise not having been fulfilled, the processor 120 can decrease the numerical value for the frequency of use of the promise related element, on the basis of the change numerical value previously set for the non-fulfillment of the corresponding promise.

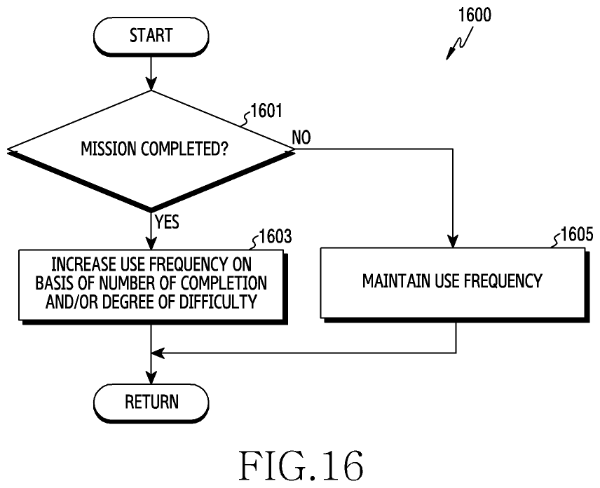

FIG. 16 is a flowchart 1600 of digitizing the frequency of use of an interaction element related to a mission in an electronic device according to various embodiments. Operations of FIG. 16 below can be at least part of a detailed operation of operation 305 of FIG. 3. FIG. 16 below is a description for a case that a determined interaction element is a mission related element. In an embodiment below, respective operations can be performed in sequence as well, but are not necessarily performed in sequence. For example, the order of the respective operations can be changed as well, and at least two operations can be performed in parallel as well. Here, the electronic device can be the electronic device 101 of FIG. 1.

Referring to FIG. 16, the electronic device (e.g., the processor 120 of FIG. 1) of various embodiments can, in operation 1601, determine whether a mission is completed. For example, the processor 120 can determine whether a mission proposed to a user has been completed by using a mission related application. According to an embodiment, the mission can be offered through a specified mission related application, and can be registered by a designer and/or user. For example, the mission can include contents related to a learning amusement and/or a five-sense development amusement, etc. For instance, the processor 120 can determine whether a first mission (e.g., a body behavior mimic mission) offered through the specified mission related application has been successfully carried out by the user.

According to various embodiments, in response to the mission having been completed, the electronic device (e.g., the processor 120) can, in operation 1603, determine a change numerical value for the frequency of use of a mission related element on the basis of the number of mission completion and/or the degree of difficulty. According to an embodiment, the processor 120 can determine the change numerical value according to the degree of difficulty previously set for the mission. For example, in response a first mission of a difficulty degree “lower” having been completed, the processor 120 can determine the change numerical value as +1 and, in response to a second mission of a difficulty degree “higher” having been completed, the processor 120 can determine the change numerical value as +3. According to an embodiment, the processor 120 can determine the change numerical value according to the number of mission completion for a corresponding mission. For example, in response to the number of mission completion accumulated for the first mission being five times or more, the processor 120 can determine the change numerical value as +2 and, in response to the number of mission completion accumulated for the first mission being less than five times, the processor 120 can determine the change numerical value as +1. According to an embodiment, the processor 120 can refine the frequency of use of the mission related element on the basis of the determined change numerical value.

According to various embodiments, in response to the mission having been completed, the electronic device (e.g., the processor 120) can, in operation 1605, maintain, without refining, the frequency of use of the mission related element.

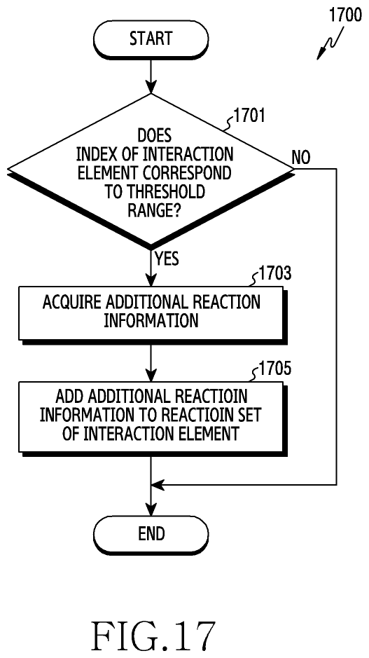

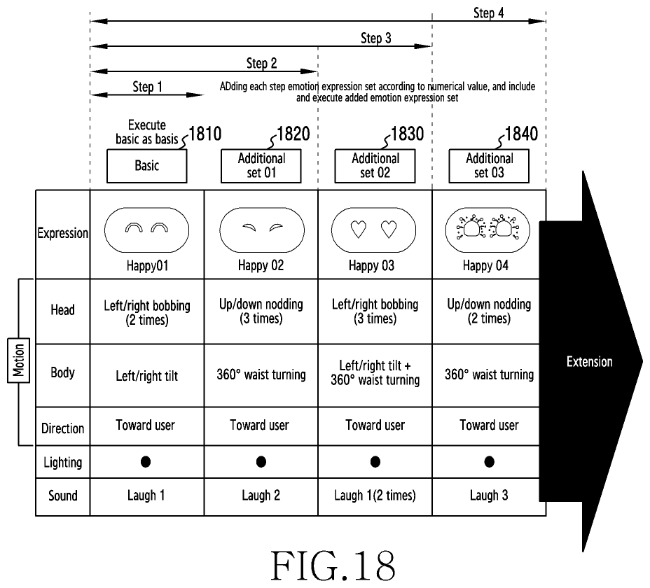

FIG. 17 is a flowchart 1700 of extending a reaction set of an interaction element in an electronic device according to various embodiments. Operations of FIG. 17 below can be at least part of a detailed operation of operation 307 of FIG. 3. In an embodiment below, respective operations can be performed in sequence as well, but are not necessarily performed in sequence. For example, the order of the respective operations can be changed as well, and at least two operations can be performed in parallel as well. Here, the electronic device can be the electronic device 101 of FIG. 1. Below, at least a partial operation of FIG. 17 will be described with reference to FIG. 18. FIG. 18 is an example diagram of extending the reaction set of the interaction element in the electronic device according to various embodiments.

Referring to FIG. 17, the electronic device (e.g., the processor 120 of FIG. 1) of various embodiments can, in operation 1701, determine whether the frequency of use of an interaction element corresponds to a threshold range. For example, the processor 120 can determine whether a use frequency refined by operation 305 of FIG. 3 corresponds to a specified threshold range. According to an embodiment, the specified threshold range can be different by interaction element as well, and can be identical as well. According to an embodiment, the specified threshold range can be changed whenever a reaction set of a corresponding interaction element is extended. For example, in response to there not being a history of the extension of a reaction set of a happy emotion element, the processor 120 can determine whether the refined use frequency corresponds to a specified first threshold range (e.g., second threshold>use frequency>first threshold) and, in response to the extension history of the reaction set of the happy emotion element existing as one time (in response to the reaction set of the happy emotion element being extended one time), the processor 120 can determine whether the refined use frequency corresponds to a specified second threshold range (e.g., third threshold>use frequency>second threshold).

According to various embodiments, in response to the frequency of use of the interaction element corresponding to the threshold range, the electronic device (e.g., the processor 120) can, in operation 1703, acquire additional reaction information about the corresponding interaction element. According to an embodiment, the processor 120 can acquire information about at least one reaction which is related to the corresponding interaction element and corresponds to a specified threshold range, from a storage (e.g., the memory 130 of FIG. 1 or the internal storage 220 of FIG. 2) of the electronic device 101, or an external electronic device (e.g., the server 108 of FIG. 1 or the wireless network database 210 of FIG. 2). For example, in response to the frequency of use of a happy emotion element corresponding to a first threshold range, the processor 120 can acquire second happy reaction information which is related to the happy emotion element while corresponding to the first threshold range. For another example, in response to the frequency of use of the happy emotion element corresponding to a second threshold range, the processor 120 can acquire third happy reaction information which is related to the happy emotion element while corresponding to the second threshold range. For further example, in response to the frequency of use of a promise related element corresponding to the first threshold range, the processor 120 can acquire reaction information (e.g., new story contents) which is related to the promise related element while corresponding to the first threshold range. For yet another example, in response to the frequency of use of a mission related element corresponding to the first threshold range, the processor 120 can acquire reaction information (e.g., contents for a next mission) which is related to the mission related element while corresponding to the first threshold range.

According to various embodiments, the electronic device (e.g., the processor 120) can, in operation 1705, add additional reaction information to a reaction set of the corresponding interaction element and extend the reaction set. According to an embodiment, the processor 120 can add acquired additional reaction information to the reaction set of the corresponding interaction element and extend the reaction set. For example, as illustrated in FIG. 18, in response to the frequency of use of a happy emotion element corresponding to a first threshold range, the processor 120 can extend a reaction set of the happy emotion element wherein the reaction set of the happy emotion element additionally includes information about a second happy reaction 1820 in a state of including only information about a first happy reaction 1810. In response to the frequency of use of the happy emotion element corresponding to a second threshold range, the processor 120 can additionally extend the reaction set of the happy emotion element wherein the reaction set of the happy emotion element additionally includes information about a third happy reaction 1830 in a state of including only the information about the first happy reaction 1810 and the information about the second happy reaction 1820. In response to the frequency of use of the happy emotion element corresponding to a third threshold range, the processor 120 can additionally extend the reaction set of the happy emotion element wherein the reaction set of the happy emotion element additionally includes information about a fourth happy reaction 1830 in a state of including only the information about the first happy reaction 1810, the information about the second happy reaction 1820, and the information about the third happy reaction 1830.

According to various embodiments, in response to the frequency of use of the interaction element not corresponding to the threshold range, the electronic device (e.g., the processor 120) can maintain, without extending, the reaction set of the corresponding interaction element as it is.

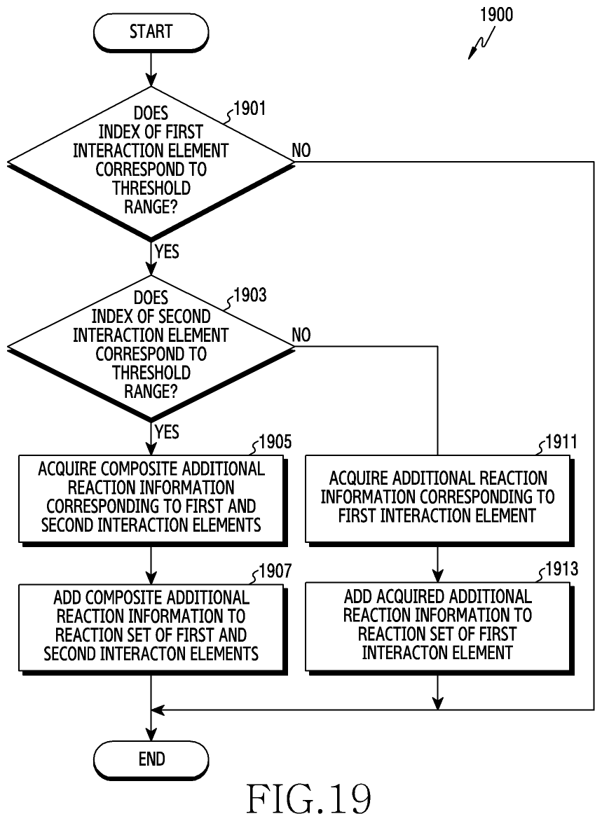

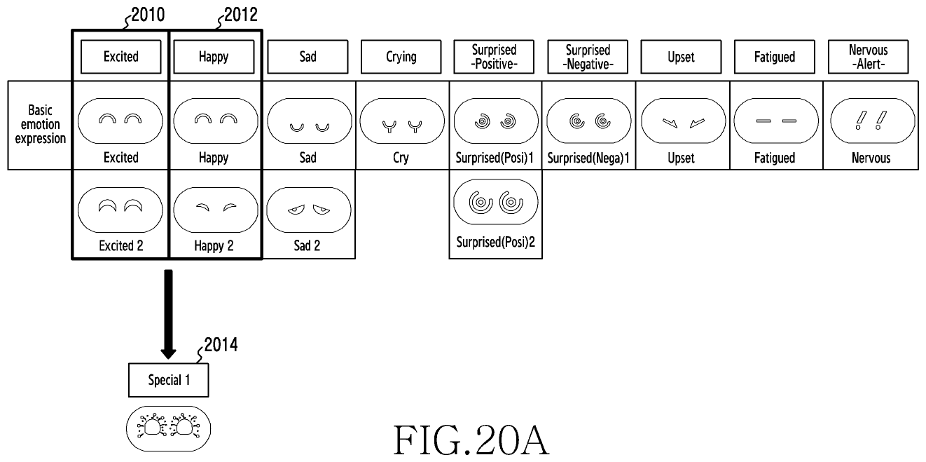

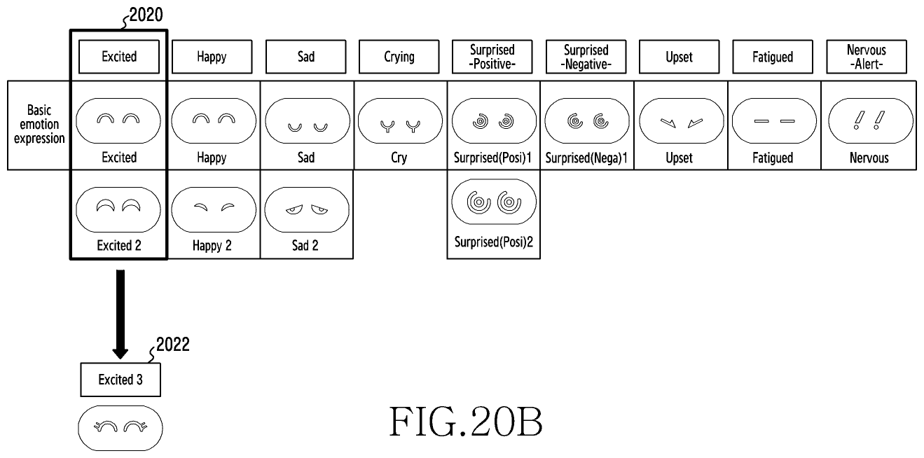

FIG. 19 is a flowchart 1900 of extending a reaction set of an interaction element in an electronic device according to various embodiments. Operations of FIG. 19 below can be at least part of a detailed operation of operation 307 of FIG. 3. In an embodiment below, respective operations can be performed in sequence as well, but are not necessarily performed in sequence. For example, the order of the respective operations can be changed as well, and at least two operations can be performed in parallel as well. Here, the electronic device can be the electronic device 101 of FIG. 1. Below, at least a partial operation of FIG. 19 will be described with reference to FIG. 20A to FIG. 20B. FIG. 20A and FIG. 20B are example diagrams of extending the reaction set of the interaction element in the electronic device according to various embodiments.

Referring to FIG. 19, the electronic device (e.g., the processor 120 of FIG. 1) of various embodiments can, in operation 1901, determine whether the frequency of use of a first interaction element corresponds to a threshold range. For example, as described in operation 1701 of FIG. 17, the processor 120 can determine whether the frequency of use of the first interaction element corresponds to a specified threshold range.

According to various embodiments, in response to the frequency of use of the first interaction element corresponding to the threshold range, the electronic device (e.g., the processor 120) can, in operation 1903, determine whether the frequency of use of a second interaction element corresponds to the threshold range. For example, the processor 120 can determine whether the frequency of use of the second interaction element which is an element having an association with the first interaction element corresponds to a specified threshold range. For example, in response to the first interaction element being an excited emotion which is a positive emotion, the processor 120 can determine whether the frequency of use of a happy emotion corresponding to the positive emotion corresponds to the threshold range.

According to various embodiments, in response to the frequency of use of the second interaction element corresponding to the threshold range, the electronic device (e.g., the processor 120) can, in operation 1905, acquire composite additional reaction information corresponding to the first and second interaction elements. According to an embodiment, the processor 120 can acquire information about at least one composite additional reaction which is related to the first interaction element and the second interaction element while corresponding to a specified threshold range, from a storage (e.g., the memory 130 of FIG. 1 or the internal storage 220 of FIG. 2) of the electronic device 101, or an external electronic device (e.g., the server 108 of FIG. 1 or the wireless network database 210 of FIG. 2). For example, as illustrated in FIG. 20A, in response to the frequency of use of an excited emotion 2010 element and the frequency of use of a happy emotion 2012 element corresponding to a second threshold range (e.g., 300>use frequency>200), the processor 120 can acquire information about a composite additional reaction 2014 which is associated with all of an excited emotion and a happy emotion while corresponding to the second threshold range.

According to various embodiments, the electronic device (e.g., the processor 120) can, in operation 1907, add the composite additional reaction information to reaction sets of the first and second interaction elements. According to an embodiment, the processor 120 can add the composite additional reaction information to each of the reaction set of the first interaction element and the reaction set of the second interaction element, and extend the reaction set of the first interaction element and the reaction set of the second interaction element.

According to various embodiments, in response to the frequency of use of the second interaction element not corresponding to the threshold range, the electronic device (e.g., the processor 120) can, in operation 1911, acquire additional reaction information corresponding to the first interaction element. According to an embodiment, the processor 120 can acquire information about at least one additional reaction which is related to the first interaction element while corresponding to a specified threshold range, from a storage (e.g., the memory 130 of FIG. 1 or the internal storage 220 of FIG. 2) of the electronic device 101, or an external electronic device (e.g., the server 108 of FIG. 1 or the wireless network database 210 of FIG. 2). For example, as illustrated in FIG. 20B, in response to the frequency of use of an excited emotion 2010 element corresponding to the second threshold range (e.g., 300>use frequency>200) but the frequency of use of a happy emotion 2012 element not corresponding to the second threshold range, the processor 120 can acquire information about a third excited reaction (Excited 3) 2022 which is associated with an excited emotion while corresponding to the second threshold range.

According to various embodiments, in response to the frequency of use of the second interaction element not corresponding to the threshold range, the electronic device (e.g., the processor 120) can, in operation 1913, add the additional reaction information to a reaction set of the first interaction element. According to an embodiment, the processor 120 can add the acquired additional reaction information to the reaction set of the first interaction element and extend the corresponding reaction set.

As described above, the electronic device 101 of various embodiments of the present disclosure can digitize the frequency of use of each interaction element, on the basis of an interaction with a user, and extend a reaction set corresponding to the corresponding interaction element on the basis of the digitized use frequency, thereby offering a reaction reflecting a user's disposition for each interaction element. For example, a reaction set of an emotion that the electronic device 101 frequently expresses includes various reaction information related to the corresponding emotion, and a reaction set of an emotion that the electronic device 101 does not frequently express includes only basic reaction information, whereby a character representing an emotion expression disposition of the electronic device 101 can be different according to the frequently expressed emotion.

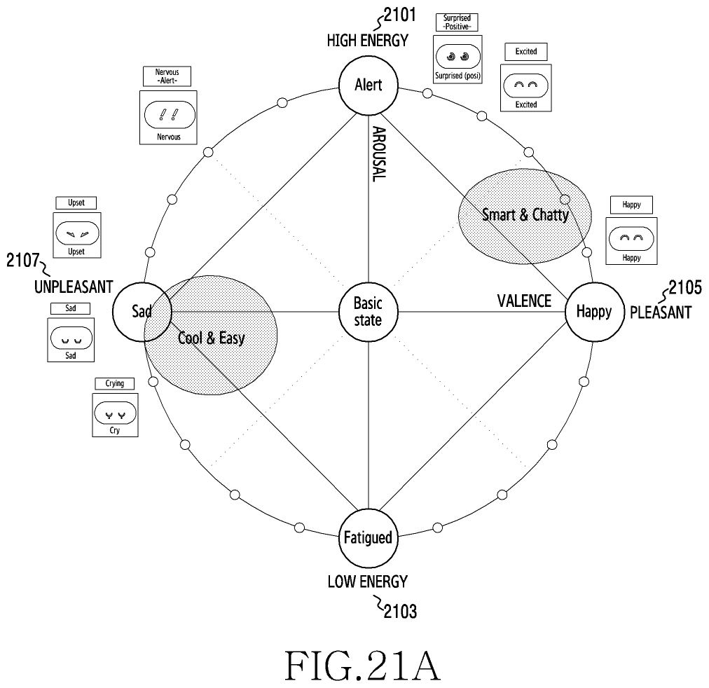

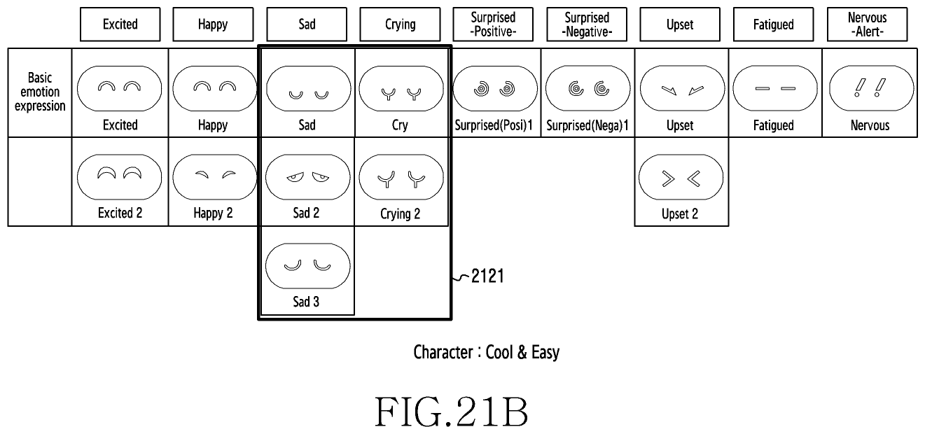

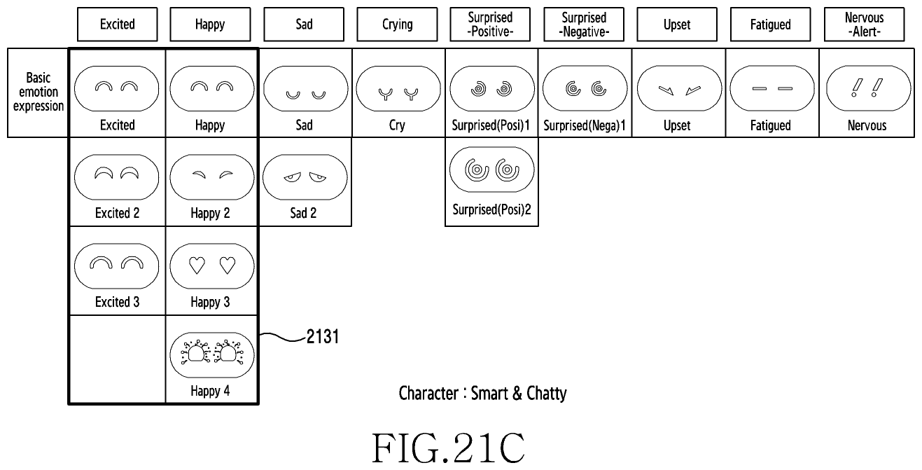

FIG. 21A is a graph showing a character of an electronic device associated with a frequently used emotion expression in an electronic device according to various embodiments. FIG. 21B and FIG. 21C are example diagrams showing a character of the electronic device associated with a reaction set for each emotion in the electronic device according to various embodiments.

Referring to FIG. 21A, various emotions can be expressed with an energy axis continued from low energy 2103 to high energy 2101 and a feeling axis continued from unpleasant 2107 to pleasant 2105. For example, in response to a user of the electronic device 101 being a calm and silent character, the electronic device 101 can much express emotions such as sad and crying, etc. being emotions close to low energy 2107 and unpleasant 2103, than other emotions, on the basis of an interaction with the user. In this case, as illustrated in FIG. 21B, a reaction set for each emotion of the electronic device 101 can be constructed in a form in which a reaction set 2121 of sad and crying emotions are much extended than a reaction set of other emotions. Accordingly to this, the electronic device 101 can offer more various reactions to the sad and crying emotions than other emotions, so it can evolve into a cool and easy character.

On the other hand, in response to the user of the electronic device 101 being a good laughing and positive character, the electronic device 101 can much express emotions such as excited and happy, etc. being emotions close to high energy 2101 and pleasant 2105, than other emotions, on the basis of the interaction with the user. In this case, as illustrated in FIG. 21C, a reaction set for each emotion of the electronic device 101 can be constructed in a form in which a reaction set 2131 of excited and happy is much extended than a reaction set of other emotions. Accordingly to this, the electronic device 101 can offer more various reactions to the excited and happy emotions than other emotions, so it can evolve into a smart and chatty character.

FIG. 21B and FIG. 21C have described that the electronic device 101 evolves into a character similar to a user character. However, to lead the change of the user character according to a design scheme, the electronic device 101 can be set to evolve into a character opposite to the user character. For example, in response to the user being a passive character, the electronic device 101 can be designed to make various active expressions during the interaction with the user and lead the user character to change into an active character.

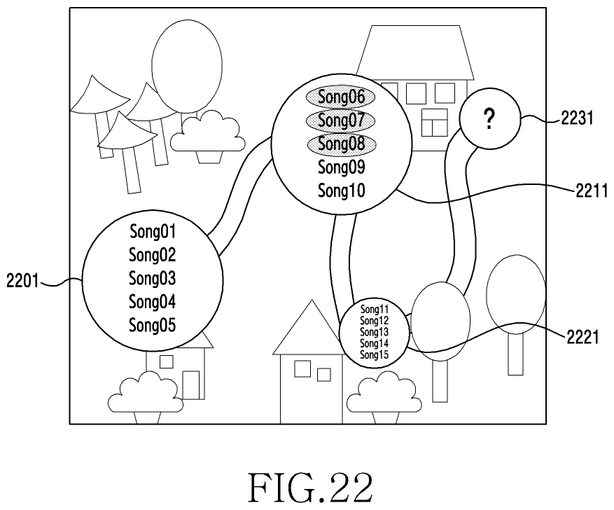

FIG. 22 is an example diagram of offering a mission according to the extension of a reaction set of a mission related element in an electronic device according to various embodiments.

Referring to FIG. 22, the electronic device 101 of an embodiment can construct a contents map by using a contents reaction set corresponding to the mission related element. For example, in response to the contents reaction set being extended to include information about an additional reaction (e.g., contents of a next mission) on the basis of the frequency of use (or score) of the mission related element, the electronic device 101 can refine the contents map on the basis of the information about the additional reaction. For instance, the electronic device 101 can increase the frequency of use of the mission related element by mission completion and add information about the next mission contents to the reaction set corresponding to the mission related element, and refine the contents map on the basis of the added information about the next mission contents and display. The contents map, for example, can include at least one of mission contents 2201 of previously completed step, mission contents 2211 of currently ongoing step, mission contents 2221 executable after the completion of the currently ongoing step, or mission contents 2231 whose information has not been offered. The electronic device 101 can add information about “song 09” and “song 10” to the reaction set of the mission related element on the basis of the completion of mission contents “song 08”. The electronic device 101 can change corresponding contents into an openable (or executable) state by a user input, on the basis of the information about “song 09” and “song 09” added to the reaction set. According to an embodiment, the electronic device 101 can accumulate and manage a change numerical value associated with mission completion, as a separate score, thereby leading a user to use for opening (or executing) desired mission contents by using the accumulated score. For example, in response to mission completion for learning contents being sensed through an interaction with the user, the electronic device 101 can manage a change numerical value for the mission completion as a separate score, and allow the user to open (or execute) amusement contents by using the corresponding score, thereby attracting user's interesting. For instance, the electronic device 101 can, not automatically extending the reaction set of the mission related element on the basis of a use frequency associated with mission completion, extend the reaction set of the mission related element in such a manner that user's selecting contents are added to the reaction set, and refine a contents map.

According to the aforementioned various embodiments, in response to an interaction element based on a user state being a promise related element, the electronic device 101 can select a reaction in a reaction set (e.g., the story reaction set 440 of FIG. 4) corresponding to the promise related element, and control at least one component wherein the selected reaction is expressed. For example, the electronic device 101 can select the most recently added new story contents in a story reaction set corresponding to the promise related element, on the basis of the frequency of use (or score) of the promise related element, and control at least one of the motors 250, the display 252, or the speaker 254 to offer the new story contents to the user. The new story contents, for example, can include story contents capable of attracting user's interesting, such as a story about a robot birth background (e.g., birthplace, family, etc.), a story about robot's favorite things (e.g., food, color, animal, etc.), or a story related to a specified promise (e.g., a vegetable story related to a vegetable eating promise, a tooth story related to a teeth brushing promise, etc.), etc. The aforementioned story contents are exemplary, and various embodiments of the present disclosure are not limited to these.

According to various embodiments, an operating method of an electronic device 101 can include determining an interaction element on the basis of a user's state which is obtained through at least one sensor (e.g., the sensor module 176, the camera module 180, and/or the input device 150 of FIG. 1), offering a reaction related to the user state on the basis of a first reaction set corresponding to the determined interaction element, refining the frequency of use of the determined interaction element, and acquiring at least one piece of other reaction information related to the determined interaction element from at least one of a memory (e.g., the memory 130 of FIG. 1, and/or the internal storage 220 of FIG. 2) or the external device on the basis of the refined use frequency and add the at least one piece of other reaction information to the first reaction set.

According to various embodiments, the interaction element can include at least one of a time element, an etiquette related element, an emotional element, a sensible element, a promise related element, or a mission related element.

According to various embodiments, offering the reaction can include, in response to information about a plurality of reactions being included in the reaction set corresponding to the determined interaction element, determining weights of the plurality of reactions, and determining one reaction among the plurality of reactions on the basis of the weights, and controlling at least one component included in the electronic device on the basis of information about the determined reaction to express the determined reaction.

According to various embodiments, the at least one component can include at least one of at least one motor, a display, an audio module, a haptic module, a sound output device, or an illumination control device.

According to various embodiments, the weights of the plurality of reactions can be determined on the basis of a time point at which each of the plurality of reactions is added to a corresponding reaction set.

According to various embodiments, refining the frequency of use of the determined interaction element can include, in response to the determined interaction element being a time element, refining the frequency of use of the interaction element on the basis of an interaction time with the user.

According to various embodiments, refining the frequency of use of the determined interaction element can include, in response to the determined interaction element being an etiquette related element, refining the frequency of use of the interaction element on the basis of whether a specified language or behavior is sensed during an interaction with the user.

According to various embodiments, refining the frequency of use of the determined interaction element can include, in response to the determined interaction element being an emotional element, refining the frequency of use of the interaction element on the basis of a priority order of the emotional element.

According to various embodiments, refining the frequency of use of the determined interaction element can include, in response to the determined interaction element being a sensible element, refining the frequency of use of the interaction element on the basis of at least one of the type of a physical interaction sensed during an interaction with the user, a strength, a time, the number of times, an area, or an accessory.

According to various embodiments, refining the frequency of use of the determined interaction element can include, in response to the determined interaction element being a promise related element, refining the frequency of use of the interaction element on the basis of whether a specified promise has been fulfilled during an interaction with the user.

According to various embodiments, refining the frequency of use of the determined interaction element can include, in response to the determined interaction element being a mission related element, refining the frequency of use of the interaction element on the basis of the number of mission completion or the degree of difficulty during an interaction with the user.

According to various embodiments, acquiring at least one piece of other reaction information related to the determined interaction element and adding the at least one piece of other reaction information to the first reaction set can include determining whether the refined use frequency corresponds to a specified threshold range, and in response to the refined use frequency corresponding to the specified threshold range, acquiring at least one piece of other reaction information which is related to the determined interaction element while being related to the specified threshold range and adding the acquired reaction information to the first reaction set, and in response to the refined use frequency not corresponding to the specified threshold range, maintaining the first reaction set.

According to various embodiments, in response to the determined interaction element being a promise related element, the at least one piece of other reaction information can include information of at least one story content related to a promise, and the operating method of the electronic device can further include offering the at least one story content related to the promise added to the first reaction set, on the basis of the frequency of use of the promise related element.

According to various embodiments, in response to the determined interaction element being a mission related element, the at least one piece of other reaction information can include information of at least one content related to a mission, and the operating method of the electronic device can further include constructing a contents map on the basis of the at least one piece of other reaction information added to the first reaction set.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.
As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).
Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor(e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.
According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.
According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
at least one sensor;
a communication module for communicating with an external device;
a memory for storing reaction sets comprising at least one piece of reaction information corresponding to each of a plurality of interaction elements; and
a processor,
wherein the processor
determines an interaction element on the basis of a user's state which is obtained through the at least one sensor,
offers a reaction related to the user state on the basis of a first reaction set corresponding to the determined interaction element,
refines the frequency of use of the determined interaction element, and
acquires at least one piece of other reaction information related to the determined interaction element from at least one of the memory or the external device on the basis of the refined use frequency and adds the at least one piece of other reaction information to the first reaction set.

2. The electronic device of claim 1, wherein the interaction element comprises at least one of a time element, an etiquette related element, an emotional element, a sensible element, a promise related element, or a mission related element.

3. The electronic device of claim 1, wherein, in response to information about a plurality of reactions being comprised in the reaction set corresponding to the determined interaction element, the processor determines weights of the plurality of reactions, and
determines one reaction among the plurality of reactions on the basis of the weights, and controls at least one component comprised in the electronic device on the basis of information about the determined reaction to express the determined reaction.

4. The electronic device of claim 3, wherein the at least one component comprises at least one of at least one motor, a display, an audio module, a haptic module, a sound output device, or an illumination control device.

5. The electronic device of claim 3, wherein the weights of the plurality of reactions are determined on the basis of a time point at which each of the plurality of reactions is added to a corresponding reaction set.

6. The electronic device of claim 1, wherein, in response to the determined interaction element being a time element, the processor refines the frequency of use of the interaction element on the basis of an interaction time with a user.

7. The electronic device of claim 1, wherein, in response to the determined interaction element being an etiquette related element, the processor refines the frequency of use of the interaction element on the basis of whether a specified language or behavior is sensed during an interaction with a user.

8. The electronic device of claim 1, wherein, in response to the determined interaction element being an emotional element, the processor refines the frequency of use of the interaction element on the basis of a priority order of the emotional element.

9. The electronic device of claim 1, wherein, in response to the determined interaction element being a sensible element, the processor refines the frequency of use of the interaction element on the basis of at least one of the type of a physical interaction sensed during an interaction with a user, a strength, a time, the number of times, an area, or an accessory.

10. The electronic device of claim 1, wherein, in response to the determined interaction element being a promise related element, the processor refines the frequency of use of the interaction element on the basis of whether a specified promise has been fulfilled during an interaction with a user.

11. The electronic device of claim 1, wherein, in response to the determined interaction element being a mission related element, the processor refines the frequency of use of the interaction element on the basis of the number of mission completion or the degree of difficulty during an interaction with a user.

12. The electronic device of claim 1, wherein the processor
determines whether the refined use frequency corresponds to a specified threshold range,
in response to the refined use frequency corresponding to the specified threshold range, acquires at least one piece of other reaction information which is related to the determined interaction element while being related to the specified threshold range and adds the acquired reaction information to the first reaction set, and
in response to the refined use frequency not corresponding to the specified threshold range, maintains the first reaction set.

13. The electronic device of claim 1, wherein, in response to the determined interaction element being a mission related element, the at least one piece of other reaction information comprises information of at least one content related to a mission, and
the processor constructs a contents map on the basis of the at least one piece of other reaction information added to the first reaction set.

14. The electronic device of claim 1, wherein, in response to the determined interaction element being a promise related element, the at least one piece of other reaction information comprises information of at least one story content related to a promise, and
the processor offers the at least one story content related to the promise added to the first reaction set, on the basis of the frequency of use of the promise related element.

15. An operating method of an electronic device, comprising:
determining an interaction element on the basis of a user's state which is obtained through at least one sensor;
offering a reaction related to the user state on the basis of a first reaction set corresponding to the determined interaction element;
refining the frequency of use of the determined interaction element; and
acquiring at least one piece of other reaction information related to the determined interaction element from at least one of the memory or the external device on the basis of the refined use frequency and adds the at least one piece of other reaction information to the first reaction set.
